(19) United States
(12) Patent Application Publication
(10) Pub. No.: US 2026/0320422 A1
(43) Pub. Date: Oct. 15, 2026

(54) GENERATING A WIKI FOR AN INTERACTIVE KNOWLEDGE BASE UTILIZED BY AN AUTONOMOUS SOFTWARE AGENT

(71) Applicant: COGNITION AI, INC., San Francisco, CA (US)

(72) Inventors: Walden Yan, Atherton, CA (US); Sampriti Panda, Menlo Park, CA (US); Mokshit Jain, New Delhi (IN); Gennady Korotkevich, Menlo Park, CA (US); Adhyyan Sekhsaria, San Francisco, CA (US); Jacob Teo, Redwood City, CA (US)

(21) Appl. No.: 19/466,974

(22) Filed: Feb. 2, 2026

Related U.S. Application Data
(60) Provisional application No. 63/770,816, filed on Mar. 12, 2025.

(51) Int. Cl. G06N 5/022; G06F 8/36; G06N 20/00

(52) U.S. Cl. CPC G06N 5/022; G06F 8/36; G06N 20/00

(57) ABSTRACT

The present disclosure relates to systems, methods, and non-transitory computer-readable media that generates a wiki for a code repository available to an autonomous software agent system. In particular, the disclosed systems access a code repository via the autonomous software agent system. Moreover, the disclosed systems generate a plurality of rich representations of the code repository using one or more machine learning models. Additionally, the disclosed systems generate a wiki from the plurality of rich representations, where the wiki includes a visualization of the plurality of rich representations. Moreover, the disclosed systems provide for display in a graphical user interface of a computing device, the wiki along with a prompt feature to search the wiki.

### CROSS REFERENCE TO RELATED APPLICATIONS

This application claims the benefit of and priority to U.S. Provisional Application No. 63/770,816, filed Mar. 12, 2025. The aforementioned application is hereby incorporated by reference in its entirety.

### BACKGROUND

Advancements in computing devices and networking technology have given rise to a variety of innovations in machine learning and digital assistants. Over time, computing systems have been developed that generate computer code to assist a developer in completing their computer tasks. For instance, some existing systems can assist software developers in generating code by supplementing/modifying existing computer code and using the generated computer code to bolster their codebase. Despite these advances, however, existing systems continue to suffer from a number of disadvantages, particularly in terms of efficiency, accuracy, and flexibility.

### SUMMARY

One or more embodiments described herein provide benefits and/or solve one or more problems in the art with systems, methods, and non-transitory computer-readable media that automatically index an interactive knowledge base and generate visualizations to aid an autonomous software agent system. To illustrate, in one or more embodiments, the disclosed systems access an interactive knowledge base and generate a plurality of rich representations of the an interactive knowledge base. In some embodiments, the disclosed systems use one or more machine learning models to generate a wiki from the plurality of rich representations. In particular, the disclosed systems generate the wiki by creating a visualization of the rich representations. Moreover, in some embodiments, the disclosed systems provide the generated wiki for display, which allows a user of a computing device to submit prompts to understand the interactive knowledge base, to search for specific features, and/or to deploy an autonomous software agent to perform one or more software coding tasks.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an overview diagram of a wiki generation system accessing an interactive knowledge base and generating a wiki of the interactive knowledge base in accordance with one or more implementations;

FIGS. 2A-2F illustrates example diagrams of the wiki generation system utilizing a plurality of machine learning models to generate a plurality of rich representations and the wiki of the code repository in accordance with one or more implementations;

FIG. 3 illustrates an example diagram of the wiki generation system utilizing various artificial intelligence models of the autonomous software agent system to generate an index of a code repository, execute a search of a code repository, and/or to deploy an autonomous software agent in accordance with one or more implementations;

FIG. 4 illustrates an example diagram of the wiki generation system monitoring a code repository and generating a modified wiki in accordance with one or more implementations;

FIGS. 5A-5B illustrates example diagrams of the wiki generation system receiving a prompt to search a code repository, receiving a deep research prompt, and/or initiating an autonomous software agent in accordance with one or more implementations;

FIG. 6 illustrates the wiki generation system utilizing the autonomous software agent system to deploy an autonomous software agent to generate computer code in accordance with one or more implementations;

FIGS. 7A-7B illustrates example diagrams of architectural components of an autonomous software agent deployed by the wiki generation system using the autonomous software agent system in accordance with one or more implementations;

FIGS. 8A-8F illustrates example graphical user interfaces of the wiki generation system generating a wiki of a code repository and executing a search of the wiki in accordance with one or more implementations;

FIG. 9 illustrates an example environment in which the wiki generation system operates in accordance with one or more implementations;

FIG. 10 illustrates an example series of acts for generating a wiki for a code repository in accordance with one or more implementations; and

FIG. 11 illustrates a block diagram of an exemplary computing device in accordance with one or more implementations.

### DETAILED DESCRIPTION

One or more embodiments described herein includes a wiki generation system that integrates with an autonomous software agent system to generate a wiki of an interactive knowledge base available to the autonomous software agent system. To illustrate, in one or more embodiments, the wiki generation system automatically indexes an interactive knowledge base available to the autonomous software agent system to generate a wiki. For example, in one or more embodiments, the wiki generation system automatically generates a wiki of a code repository includes detailed documentation, architecture diagrams with source code links, code conventions, and other abstraction summaries that convey a clear understanding of the code repository. Moreover, in one or more embodiments, the wiki generation system monitors the accessed interactive knowledge base to automatically update/refresh the generated wiki to reflect any changes. In other words, the wiki generation system provides a living and breathing detailed documentation resource to software development teams.

In one or more embodiments, the wiki generation system allows a user of a computing device to further search (e.g., using the generated wiki) for specific features within an interactive knowledge base. Further, in some embodiments, for software features already implemented into a code repository, the wiki generation system also allows a user of a computing device to identify (e.g., using the generated wiki) specific commits within the code repository and even investigate potential computer code bugs in the code repository.

In some embodiments, beyond searching for computer code/specific features within a code repository, the wiki generation system allows a user to submit a prompt to pull together relevant context for a specific software coding task. Moreover, after the user of the computing device pulls together relevant context for the specific software coding task, the wiki generation system allows the user of the computing device to kick-off/initiate an autonomous software agent session (e.g., a Devin session that deploys an autonomous artificial intelligence engineer).

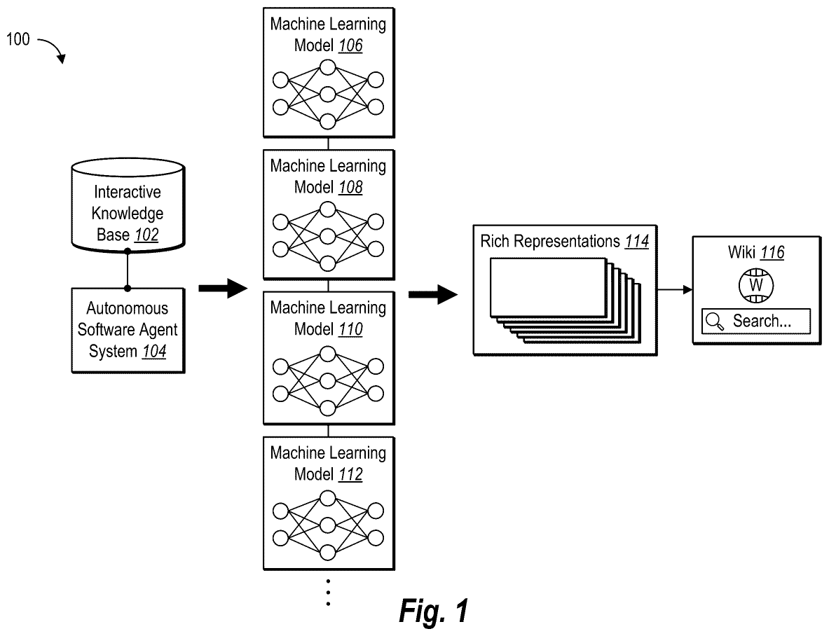

As shown in FIG. 1, a wiki generation system 100 generates a wiki of an interactive knowledge base available to an autonomous software agent system in accordance with one or more embodiments. For example, FIG. 1 shows the wiki generation system 100 accessing an interactive knowledge base 102 (e.g., the interactive knowledge base 102 for which access is provided to an autonomous software agent system 104) and using one or more machine learning models to generate rich representations of the interactive knowledge base 102.

As shown in FIG. 1, in response to determining a connection between the interactive knowledge base 102 and the autonomous software agent system 104, the wiki generation system 100 initiates a process to generate/index the interactive knowledge base 102. In one or more embodiments, the interactive knowledge base 102 refers to a structured, machine-readable collection of information assets that is stored in one or more non-transitory computer-readable media and configured to be dynamically accessed, queried, modified, and extended through user interaction and/or automated processes. The interactive knowledge base comprises interrelated data objects, metadata, and relationships that collectively represent domain knowledge and enable contextual navigation, retrieval, and manipulation of that knowledge. In one or more embodiments, the interactive knowledge base is a code repository. In such an implementation, the interactive knowledge base includes a plurality of source code files, configuration files, documentation, and associated metadata organized according to a defined structure (e.g., directories, modules, or packages). For example, the interactive knowledge base 102 (when a code repository) includes computer code, computer code documentation (e.g., files explaining how to use, setup, and contribute to one or more projects), configuration files (environment configuration, application configuration, deployment configuration, etc.), and assets (images, CSS files, JavaScript files, fonts, external libraries, audio/video files, etc.). For example, software applications/systems utilize one or more code repositories to organize computer code, collaborate on computer code projects, and maintain computer code over time. In other words, the interactive knowledge base 102 enables multiple software developers to collaborate on computer code projects (e.g., software development teams can upload and download changes to and from the code repository) by creating branches to work on specific features or computer code bugs, and once a branch is completed, merging their changes into the interactive knowledge base 102 that software developers can access.

As shown in FIG. 1 and mentioned above, the wiki generation system 100 performs an indexing process of the interactive knowledge base 102. In particular, the wiki generation system 100 utilizes at least one of a machine learning model 106, a machine learning model 108, a machine learning model 110, or a machine learning model 112, etc. to “index” the interactive knowledge base 102. For example, by using the one or more machine learning models, the wiki generation system 100 generates rich representations 114 of the interactive knowledge base 102.

In one or more embodiments, the rich representations 114 refers to detailed, complex, and informative representations of the interactive knowledge base 102 that contain multiple layers of information or features related to the code repository. For example, the rich representations 114 include high-level abstractions of data in the interactive knowledge base 102. In particular, the rich representations 114 act as high-level input representations to downstream models for further processing (e.g., processing by a multi-modal large language model to generate an output, such as a wiki or a response to a prompt to search the interactive knowledge base).

In one or more embodiments, the wiki generation system 100 uses one or more machine learning models (e.g., Devin's Brain) to index the interactive knowledge base 102 and generate the plurality of rich representations. In particular, the rich representations 114 (e.g., generated from the indexing process of the interactive knowledge base 102) refers to an abstraction summary of the interactive knowledge base 102. In particular, the wiki generation system 100 subdivides/breaks down the interactive knowledge base 102 into core parts and determines the structure and hierarchy of the interactive knowledge base (i.e., generates the rich representations 114). For example, the wiki generation system 100 utilizes one or more machine learning models to analyze the interactive knowledge base 102 and determine the purpose of different parts of the interactive knowledge base, how files are organized in the interactive knowledge base 102, and different methods and technologies in the interactive knowledge base 102.

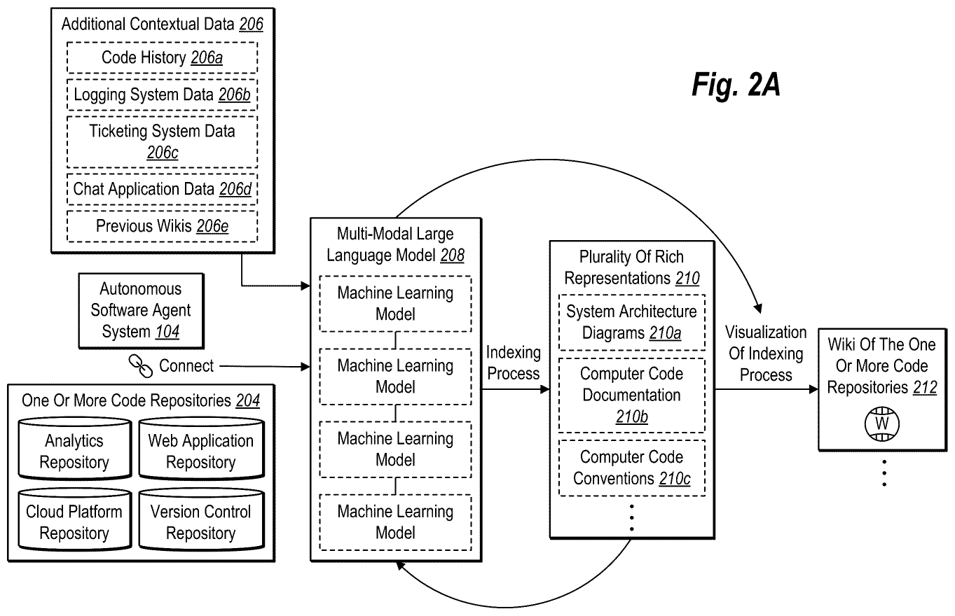

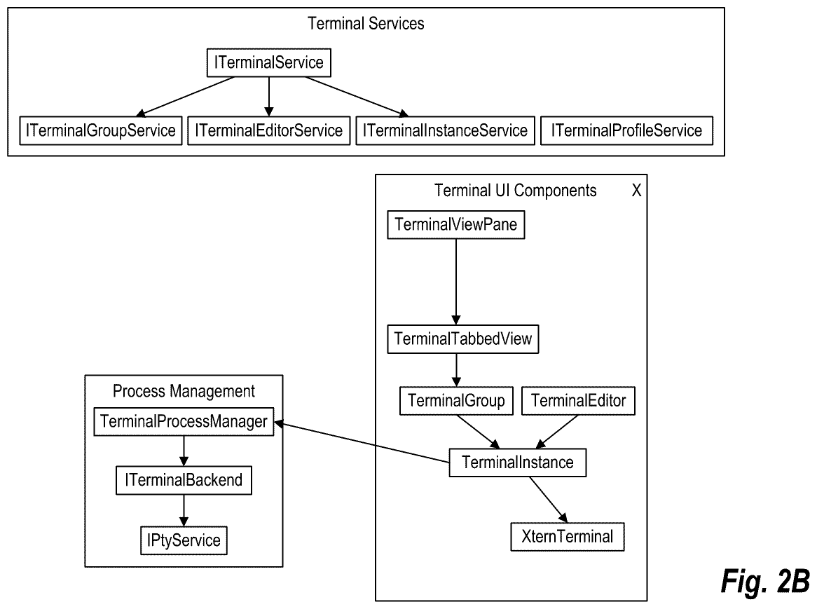

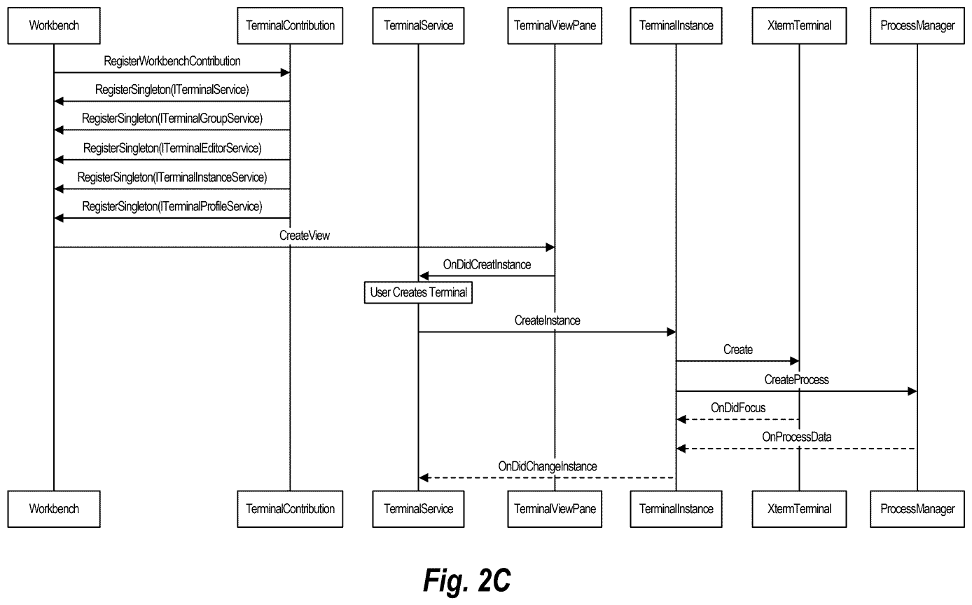

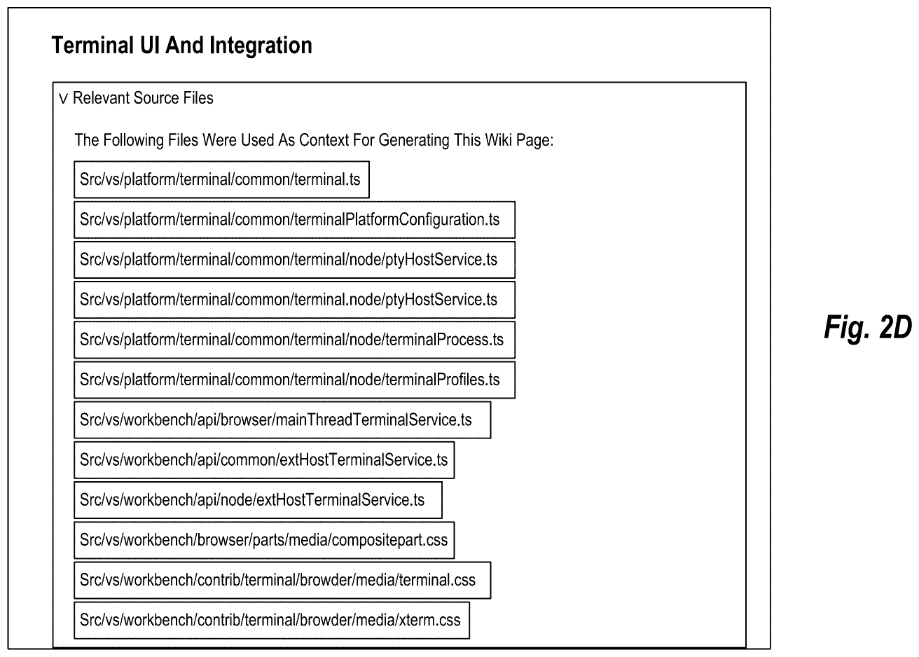

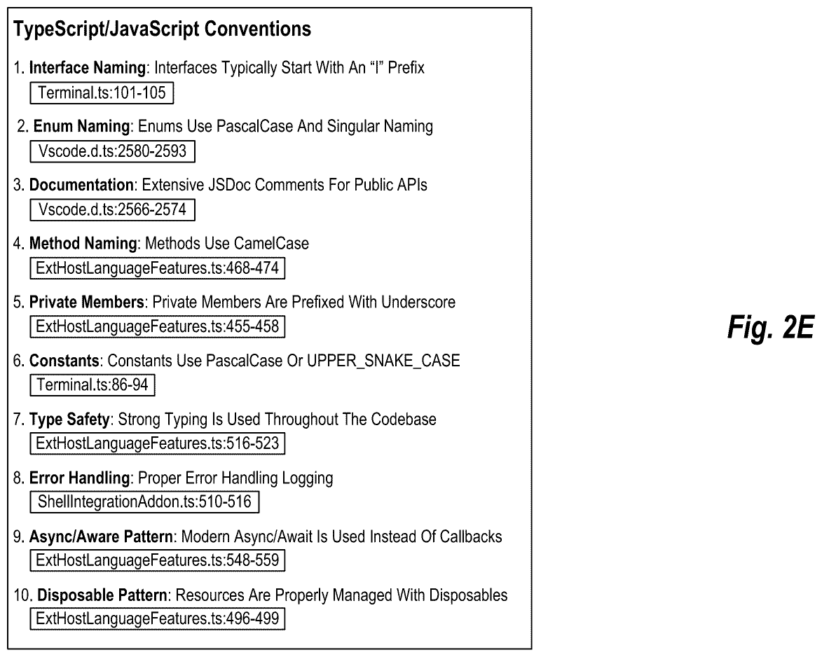

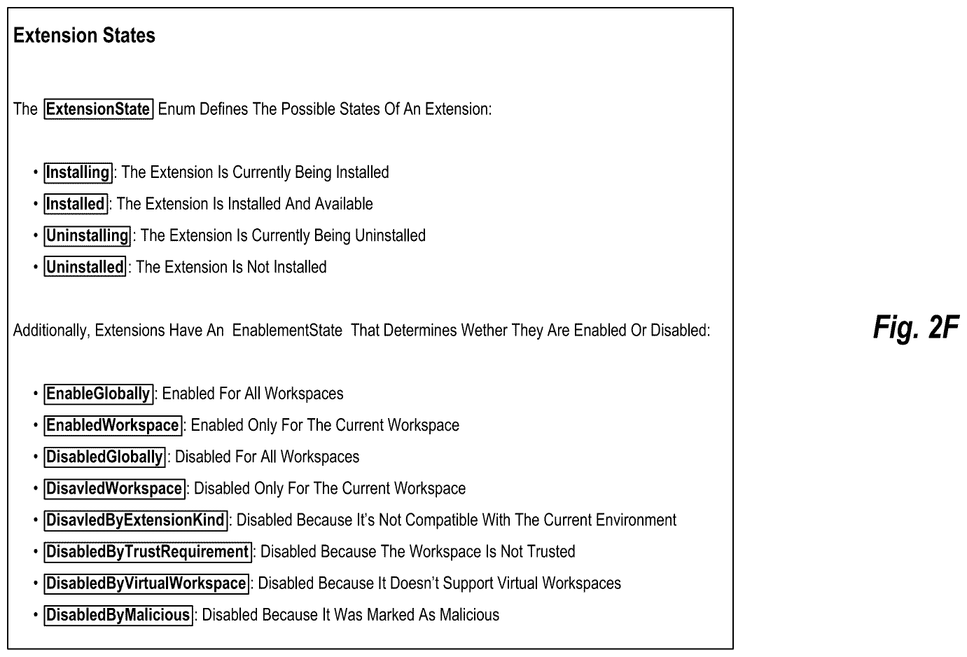

In one or more embodiments, the wiki generation system 100 generates the rich representations 114 using the machine learning models by identifying/determining a purpose of the interactive knowledge base 102, the key features of the interactive knowledge base 102 the computer languages in the interactive knowledge base 102, the technology stack, different files, and external libraries. In particular, from identifying/determining these aspects, the wiki generation system 100 extracts system architecture diagrams from the interactive knowledge base 102, computer code documentation, and computer code conventions. Specific details of how the wiki generation system 100 uses the machine learning models to generate the rich representations 114 is given below in the description of FIG. 2A.

As also shown in FIG. 1, the wiki generation system 100 further creates a wiki 116 of the interactive knowledge base from the rich representations 114. In one or more embodiments, the wiki generation system 100 utilizes the one or more machine learning models to generate a visualization (e.g., a wiki) of the generated index of the interactive knowledge base. In other words, wiki generation system 100 creates a visualization of the process in which the wiki generation system 100 uses to parse through (e.g., index) the interactive knowledge base 102.

In some embodiments, the created visualization (e.g., the wiki 116) of the interactive knowledge base 102 can be provided to a user of a computing device to better understand the system architecture, the code conventions, and the key features/functionalities of the code repository. In particular, the wiki generation system 100 generates the wiki 116, which is an ordered arrangement of the rich representations 114 according to an abstracted outline/table of contents determined from processing the interactive knowledge base 102 with the one or more machine learning models. Additional details of an exemplary wiki 116 of an interactive knowledge base in the form of a code repository are provided below in the description of FIGS. 2A-2F. One will appreciate, however, in alternative implementations, the wiki generation system 100 generates a wiki of an interactive knowledge base other than a code repository.

As mentioned above, existing systems are inefficient. For example, existing systems provide code generation assistant features to assist a developer in completing their software tasks. However, these existing systems merely supplement developer work. In particular, existing systems require heavily involved guidance, prompting, monitoring, and the use of a developer's device in order to supplement developer work. In other words, existing systems merely act as a co-pilot to a developer.

Due to newer or less experienced developers lacking a thorough understanding of a code repository, these developers often inefficiently leverage code generation assistant features. Accordingly, existing systems suffer from newer or less experienced developers prompting and re-prompting code generation assistants to create supplementary code that does not operate correctly with a code repository. Further, existing systems suffer from computational inefficiencies of attempting to integrate a code development assistant into a developer's workflow and often suffer from being prompted and re-prompted to yield satisfactory results.

Relatedly, existing systems often generate supplementary computer code that has a high failure rate of actually being implemented into a code base. In particular, based on the just-mentioned problems, existing systems use code generation assistants to assist a developer, but often lack an intimate, thorough, and advanced understanding of a codebase (e.g., code repository) on which a developer is working. As such, existing systems generate computer code to supplement a developers work or develop computer code that needs a lot of oversight/review to put it in a condition that is sufficiently useful.

Moreover, existing systems often operate on extremely complex codebases. In particular, existing systems often use codebases with hundreds, thousands, or hundreds of thousands of files, configurations, code conventions, and documentation. As such, newly added developers to a software development team are often missing key context and nuance surrounding how a complex codebase operates.

Accordingly, newly added developers further exacerbate efficiency issues by relying too heavily on code generation assistants. In other words, newly added developers may leverage code generation assistants to generate supplementary computer code, however because of the lack of experience and knowledge of the newly added developers, they fail to catch incorrect computer code. Thus, existing systems suffer from integrating computer code that does not operate correctly, which further increase the time and resources used to fix up the faulty code in a codebase.

As alluded to above, in addition to their inefficiency issues, existing systems are also inaccurate. More particularly, due to the standard paradigm of existing systems supplementing code development, existing systems are often incomplete or inadequate in generating complex and extensive computer code. Moreover, existing systems often supplement code development efforts but generate computer code that inaccurately addresses an intent (expressed by an input prompt) and/or that is operationally invalid, including syntactic errors, semantic errors, logical errors, and/or errors that result from a lack of understanding of a complex set of code repositories. This is often due to developers not understanding the ins-and-outs of a code repository and these developers incorrectly prompting code generation assistants.

Relatedly, existing systems further suffer from operational inflexibility. Because existing systems are limited to supplementing code development for cases expressly coded by engineers, these existing systems fail to adapt to creating new computer code, tackling complex non-trivial tasks, understanding already generated computer code and/or performing tests on computer code. Indeed, the inflexible nature of existing systems severely hampers the ability of existing systems to keep up with the taxing demands of software development from a holistic perspective, especially in the context of complex code repositories.

In one or more embodiments, the wiki generation system 100 provides several improvements over conventional systems in relation to efficiency, accuracy, and operational flexibility. For example, in some embodiments, the wiki generation system 100 improves efficiency relative to existing systems. In contrast to existing systems which lack an intimate, thorough, and advanced understanding of a code base that a developer is working on, the wiki generation system 100 performs indexing of a code repository (e.g., available to the autonomous software agent system 104) to generate rich representations and further generates a wiki from the rich representations.

In generating the rich representations and the wiki, the wiki generation system 100 allows newer and less experienced software developers to quickly and efficiently get up to speed on the nuances and complexities of a code repository. In doing so, the wiki generation system 100 provides a living and breathing documentation of one or more code repositories to a team of software developers, which assists software developers to more effectively prompt computer code generation systems.

The wiki generation system 100 can further improve efficiency by allowing users to search a code repository. Rather than relying on a code generation assistant to blindly execute tasks, the wiki generation system 100 further allows a user to submit prompts to search a generated wiki of a code repository to gather the relevant context and computer code in the code repository. Further, after gathering the relevant context and computer code, the wiki generation system 100 can deploy an autonomous software agent to execute a software task based on the relevant context and computer code. Thus, the wiki generation system 100 enables a user of a computing device to more effectively utilize artificial intelligence to generate computer code by pulling together the relevant context via prompts.

In other words, the wiki generation system 100 reduces inefficiencies by using an autonomous software agent system that has a thorough and intimate understanding of a code repository. In other words, wiki generation system 100 compensates for the inexperience of newly added developers by generating rich representations of a code repository and further generating a wiki. Effectively allowing newly added developers to submit prompts regarding the code repository. Thus, the wiki generation system 100 reduces the time and resources used to fix up faulty code caused by newly added software developers (e.g., by using artificial intelligence to more effectively generate computer code based on pulled together context).

In some embodiments, the wiki generation system 100 uses the autonomous software agent system 104 to silo/isolate autonomous software agents such that the autonomous software agents can efficiently perform their assigned tasks (e.g., without being bogged down by additional information). In other words, the wiki generation system 100 does not merely act as a “co-pilot” or a supplementary assistant but acts as an autonomous independent software agent that efficiently performs complex computer code tasks based on a generated wiki of a code repository.

In contrast to existing systems, which are often incomplete or inadequate in generating complex and extensive computer code for complex code repositories, the wiki generation system 100 further improves accuracy. In particular, the wiki generation system 100 initially obtains a thorough and nuanced understanding of a code repository/environment.

As a result, the wiki generation system 100 can more accurately generate responses to prompts regarding a code repository (e.g., using the generated rich representations and the generated wiki) and can further deploy an autonomous software agent that determines how to generate computer code that matches a determined context. Accordingly, the wiki generation system 100 more accurately generates complex and extensive computer code, especially in the context of newly added developers leveraging computer code generation models.

In one or more embodiments, the wiki generation system 100 further improves upon operational inflexibilities. In contrast to existing systems, which are rigidly tied to code supplementation, the wiki generation system 100 allows a user to pull together relevant context for a software task (e.g., via submitting prompts to search a generated wiki). Moreover, the wiki generation system 100 uses the autonomous software agent system 104 to deploy an autonomous software agent that operates as an independent virtual machine computing device and further allows a user to monitor/modify the progress of the autonomous software agent (if so desired).

Thus, the wiki generation system 100 provides advanced and intelligent search features for code repositories available to the autonomous software agent system 104 to assist software developers to more effectively get up to speed on a code repository. Furthermore, the wiki generation system 100 also provides advanced computer code generation features based on searches of a code repository.

Moreover, because the wiki generation system 100 uses the autonomous software agent system 104 to deploy an autonomous software agent that is provided with various development box tools (e.g., browser, planner, editor, and shell), the wiki generation system 100 acts as an advanced reasoning tool to complete non-trivial tasks. Accordingly, the wiki generation system 100 enhances the flexibility of operations in understanding a code repository and performing code generation tasks.

As mentioned above, the wiki generation system 100 generates a wiki of a code repository that is available to the autonomous software agent system. FIG. 2A illustrates the wiki generation system 100 using one or more machine learning models (e.g., of the autonomous software agent system 104) to generate a plurality of rich representations in accordance with one or more embodiments. FIG. 2A shows that in some embodiments, the wiki generation system 100 generates a plurality of rich representations 210 in response to the autonomous software agent system 104 connecting with one or more code repositories 204.

In some embodiments, the wiki generation system 100 utilizes the autonomous software agent system 104 to seamlessly synchronize with code repositories (e.g., code repository organization managers, such as Git Managers). In particular, when users of computing devices sign up for an account with the autonomous software agent system 104, the users of the computing devices can connect with their code repository organization (Github organization), which involves installing a code repository application (e.g., Github application) into their workspace. Moreover, the wiki generation system 100 utilizes the autonomous software agent system 104 to provide an option to specify a personal access token if the user does not have the permissions to install the code repository application into their organization.

Moreover, as mentioned, the wiki generation system 100 utilizes the autonomous software agent system 104 to provide integration with a code repository, which allows the autonomous software agent system 104 to do various actions, such as creating PULL requests, commenting on repository group pull requests, and reviewing repository group actions (e.g., their code did not pass the check you cannot merge this code).

In addition, the wiki generation system 100 utilizes the autonomous software agent system 104 to obtain a thorough understanding of a code repository. As shown in FIG. 2A, the wiki generation system 100 utilizes the autonomous software agent system 104 to access an analytics repository, a web application repository, a cloud platform repository, and a version control repository. As mentioned above, the wiki generation system 100 utilizes the autonomous software agent system 104 to access the shown code repositories based on a user of a computing device granting access permissions to the code repositories.

As further shown in FIG. 2A, the wiki generation system 100 draws upon additional contextual data 206 to generate the plurality of rich representations 210. In one or more embodiments, the wiki generation system 100 uses the one or more code repositories 204 and the additional contextual data 206 to generate the plurality of rich representations 210. In particular, the additional contextual data 206 refers to data in addition to the immediate code repository (e.g., additional metadata, files, external systems, etc.).

As shown in FIG. 2A, in some embodiments, the additional contextual data 206 includes code history 206a, logging system data 206b, ticketing system data 206c, chat application data 206d, and/or previous wikis 206e. In one or more embodiments, the code history 206a refers to a record of changes made to the code repository. For example, the code history 206a includes modifications, additions, deletions, and updates to the computer code.

Further, the code history 206a can include timestamps, author information, and comments describing various changes to computer code. In some embodiments, the code history 206a is external to the code repository and refers to snapshots/states of the code repository over time. In particular, the code history 206a can be stored in an external database (e.g., external to the code repository). Accordingly, the wiki generation system 100 can leverage the code history 206a to generate the plurality of rich representations 210.

In one or more embodiments, logging system data 206b refers to a record of information regarding operations, events, and activities in a software system. For example, the logging system data 206b can include a log of data from client devices interacting with a software system. In particular, a logging system can exist external to the code repository and monitors various interactions with a software system. Moreover, the logging system can collect, store, and analyze the data for diagnosing, tracking, and monitoring the state of a software application. Accordingly, the wiki generation system 100 can leverage the logging system data 206b to generate the plurality of rich representations 210.

In one or more embodiments, a ticketing system refers to a software tool to track tasks, bugs, and features. For example, a ticketing system allows software development teams to manage and prioritize their workload, assign tasks, and track the progress of tasks. In particular, a ticketing system typically provides options for users to submit issue tickets that include various fields describing a task, a workflow to assign the ticket to a silo of developers, comments on the ticket, attachments for the ticket, and linked issues. Accordingly, the wiki generation system 100 leverages the ticketing system data 206c extracted from a ticketing system to generate the plurality of rich representations 210.

In one or more embodiments, a chat application refers to a software tool for digital communication and collaboration between different users, teams, and organizations. In particular, a chat application provides text-based messaging for group chats and direct messages between users to enhance interactions, especially in the context of software development. In some embodiments, the wiki generation system 100 extracts the chat application data 206d to generate the plurality of rich representations 210.

Moreover, as also shown in FIG. 2A, in some embodiments, the wiki generation system 100 uses previous wikis 206e to generate the plurality of rich representations 210 and eventually a wiki 212. In one or more embodiments, the previous wikis 206e refer to already generated wikis of code repositories. In particular, the previous wikis 206e can refer to publicly available wikis for public code repositories, wikis generated by an account associated with the one or more code repositories 204, or other wikis corresponding to third-party code repositories that a user account has access to. Additional details of using the previous wikis 206e to generate the wiki 212 is given below.

Moreover, FIG. 2A shows the wiki generation system 100 utilizing the autonomous software agent system 104 to generate the plurality of rich representations 210 of the code repositories. In one or more embodiments, the wiki generation system 100 uses a multi-modal large language model 208 (e.g., one or more multi-modal large language models) of the autonomous software agent system 104 (e.g., Devin's Brain) to generate the plurality of rich representations 210.

In some embodiments, the wiki generation system 100 uses the autonomous software agent system 104 that includes one or more machine learning models, neural networks, and/or large language models. As shown in FIG. 2A, the wiki generation system 100 uses the autonomous software agent system 104 which leverages various machine learning components used to analyze, process, and generate information.

In one or more embodiments a machine learning model includes a computer algorithm or a collection of computer algorithms that can be trained and/or tuned based on inputs to approximate unknown functions. For example, a machine learning model can include a computer algorithm with branches, weights, or parameters that changed based on training data to improve for a particular task. Thus, a machine learning model can utilize one or more learning techniques to improve in accuracy and/or effectiveness. Example machine learning models include various types of decision trees, support vector machines, Bayesian networks, random forest models, or neural networks (e.g., deep neural networks).

Similarly, a neural network includes a machine learning model of interconnected artificial neurons (e.g., organized in layers) that communicate and learn to approximate complex functions and generate outputs based on a plurality of inputs provided to the model. In some instances, a neural network includes an algorithm (or set of algorithms) that implements deep learning techniques that utilize a set of algorithms to model high-level abstractions in data.

To illustrate, in some embodiments, a neural network includes a convolutional neural network, a recurrent neural network (e.g., a long short-term memory neural network), a transformer neural network, a generative adversarial neural network, a graph neural network, a diffusion neural network, a multi-layer perceptron, a large language model (LLM), a generative pre-trained transformer model (GPT), a chain-of-thought machine learning model, etc. In some embodiments, a neural network includes a combination of neural networks or neural network components.

In one or more embodiments, the one or more machine learning models include a language model that includes a set of statistical or probabilistic functions to perform Natural Language Processing (NLP) in order to understand, learn, and/or generate human natural language content. For example, the wiki generation system 100 uses the autonomous software agent system which uses a language model as a tool that determines the probability of a given sequence of words occurring in a sentence or natural language sequence.

Simply put, the wiki generation system 100 uses the autonomous software agent system 104 which uses a model that is trained to predict the next word in a sentence. A language model is called a large language model (LLM) when it is trained on an enormous amount of data (e.g., a threshold amount of data) and/or has a large number of parameters. These models have capabilities ranging from writing a simple essay to generating complex computer codes-all with limited to no supervision. Accordingly, an LLM can comprise a deep neural network that is very large (billions to hundreds of billions of parameters) and understands, processes, and produces human natural language by being trained on massive amounts of text.

These models predict future words in a sentence letting them generate sentences similar to how humans talk and write or otherwise in a form dictated, for instance, by a prompt. In one or more implementations, an LLM utilized by the autonomous software agent system employs a “chain-of-thought” reasoning approach that allows the model to internally deliberate before providing responses. Indeed, one or more implementations include a LLM trained using reinforcement learning techniques that enable the LLM to refine its reasoning skills through iterative feedback.

As shown in FIG. 2A, the wiki generation system 100 uses an indexing process to analyze the one or more code repositories 204 and generate the plurality of rich representations 210, where the indexing process refers to creating an abstraction summary of the one or more code repositories 204. As mentioned above, the wiki generation system 100 generates the plurality of rich representations 210 using the autonomous software agent system 104 to subdivide/break down a code repository into core parts and determines a structure, organization, and hierarchy of the one or more code repositories.

In one or more embodiments, the wiki generation system 100 uses the multi-modal large language model 208 to generate the plurality of rich representations 210. For example, the wiki generation system 100 uses the multi-modal large language model 208 to generate a plurality of embeddings. In particular, the wiki generation system 100 generates code repository embeddings (e.g., vector representations) of the one or more code repositories 204 and contextual data embeddings of the additional contextual data 206. Furthermore, the wiki generation system 100 compares the generated embeddings within a unified latent space (e.g., multi-dimensional latent space) and generates the plurality of rich representations 210.

In one or more embodiments, the wiki generation system 100 uses the multi-modal large language model 208 to generate embeddings from textual elements within the one or more code repositories 204. In particular, the wiki generation system 100 utilizes a text encoder to generate a representation of the textual elements (e.g., such as a text token) for a machine learning task. In some embodiments, a single text token refers to a word, a sub-word, or a character (e.g., “the,” “on,” “cat,” “t,” “showcasing,” “show,” “casing,” etc.). Furthermore, the wiki generation system 100 uses the multi-modal large language model 208 to generate tokens representing special meaning or purposes such as the beginning or an end of a sentence.

Further, in some embodiments, the wiki generation system 100 also uses a text encoder to generate representations of the additional contextual data 206. Moreover, in some embodiments, the wiki generation system 100 further processes image data from documents in the one or more code repositories 204. In particular, the wiki generation system 100 utilizes an image encoder to encode image data and generate image embeddings of visual elements in the one or more code repositories 204.

In one or more embodiments, an image encoder is a neural network (or one or more layers of a neural network) that extract features relating to digital images. In some cases, an image encoder refers to a neural network that both extracts and encodes features from a digital image. For example, an image encoder can include a particular number of layers including one or more fully connected and/or partially connected layers of neurons that extract image patches from the digital image and encode localized features of the digital image. To illustrate, in one or more embodiments, the wiki generation system 100 generates an image embedding (e.g., extracts raw data) that represents a complete frame of a digital image (e.g., images in the one or more code repositories 204).

In one or more embodiments, the wiki generation system 100 utilizes the image encoder to generate image embeddings. In some embodiments, the image embeddings include a numerical representation (e.g., a vector) of a digital image. For instance, the image embeddings capture features and properties of the digital image. To illustrate, the image embeddings include semantic information such as the presence of objects, shapes, and spatial relationships. Additionally, in some embodiments, the wiki generation system 100 further utilizes the text encoder and/or the image encoder to generate embeddings for the additional contextual data 206.

Moreover, the wiki generation system 100 projects the image embeddings into a unified latent space with text embeddings and leverages, a multi-modal artificial intelligence model (e.g., a multi-modal LLM) to generate predictions regarding the processed information (e.g., generate the plurality of rich representations 210). In other words, the wiki generation system 100 uses the multi-modal large language model 208 (e.g., of the autonomous software agent system) to work with various data domains and can perform a wide variety of reasoning tasks to determine how to generate the abstraction summaries (e.g., the structure, hierarchy, and organization) of the one or more code repositories 204.

In one or more embodiments, the wiki generation system 100 uses a first machine learning model (e.g., of one or more machine learning models) to process a first section of a first code repository and generate a subset of the plurality of rich representations 210. Moreover, in parallel, the wiki generation system 100 further uses a second machine learning model to process a second section of the first code repository and generate an additional subset of the plurality of rich representations 210.

In other words, the wiki generation system 100 can use a plurality of machine learning models in parallel to more effectively and accurately generate the plurality of rich representations 210. In particular, the wiki generation system 100 can select certain machine learning models to process certain types of data within a code repository based on factors such as model size, computational efficiency, accuracy, etc. Moreover, as shown in FIG. 2A, the wiki generation system 100 generates the plurality of rich representations 210 which can include system architecture diagrams 210a, computer code documentation 210b, and computer code conventions 210c. Additional details of this is given below in FIGS. 2B-2F.

Moreover, FIG. 2A shows the wiki generation system 100 generating the wiki 212 of the one or more code repositories 204. In particular, FIG. 2A shows the wiki generation system utilizing the multi-modal large language model 208 to process the plurality of rich representations 210 and generate the wiki 212. For example, FIG. 2A shows the wiki generation system 100 performing a visualization of the indexing process to generate the wiki 212 from the plurality of rich representations 210.

In one or more embodiments, the wiki generation system 100 uses the multi-modal large language model 208 to generate the wiki 212 by leveraging the above-mentioned embeddings. In particular, as mentioned above, the wiki generation system 100 generates code repository embeddings and contextual data embeddings to generate the plurality of rich representations 210, which represent a structure, hierarchy, and organization of elements within the one or more code repositories 204.

Moreover, to generate the wiki 212, the wiki generation system 100 uses the multi-modal large language model 208 to transform textual and visual embeddings into text and images (e.g., via a decoder of the multi-modal large language model 208) and further organizes the textual and visual embeddings according to the structure, hierarchy, and organization indicated by the plurality of rich representations 210 (e.g., the index of the one or more code repositories). In other words, the wiki generation system arranges the text and images (e.g., from the textual and visual embeddings) according to an outline/table of contents (e.g., sections, chapters, pages) abstracted from a code repository.

In one or more embodiments, the wiki generation system 100 utilizes the one or more machine learning models of the autonomous software agent system 104 to generate a visualization (e.g., a wiki) of the generated index of the code repository. In other words, the wiki generation system 100 generates a visualization of the process in which the autonomous software agent system 104 uses to parse through the code repository. For example, the created visualization (e.g., wiki) of the code repository can be provided to a user of a computing device to better understand the system architecture, the code conventions, and the key features/functionalities of the code repository.

To illustrate, the wiki generation system 100 can generate the wiki 212 that includes a plurality of sections (e.g., a code architecture overview, a core services and components section, a debugging system, a terminal system, a task system, etc.) and a plurality of subsections for each of the plurality of section. In particular, the wiki generation system 100 uses the process discussed above to generate the plurality of rich representations 210, where each rich representation relates to a different section/subsection of the wiki.

Moreover, during the process of indexing a connected code repository, the wiki generation system 100 abstracts/generates an outline/table of contents of the code repository. In some embodiments, the wiki generation system 100 assigns a first subset of rich representations to an overview section, a second subset of rich representations to core services and components sections, a third subset of rich representations to a debugging system, etc. In other words, the wiki generation system 100 indexes a code repository and then visualizes the indexing process to generate the wiki 212.

In one or more embodiments, to generate the outline/table of contents of a connected code repository, the wiki generation system 100 uses a reasoning model (e.g., chain-of-thought reasoning) to decompose the connected code repository into discrete tasks. In particular, the wiki generation system 100 performs advanced reasoning to analyze the code repository into a step-by-step process. For example, the wiki generation system 100 utilizes a chain of thought reasoning model to mimic human-like reasoning by breaking down the code repository/task into smaller, more manageable portions. In doing so, the wiki generation system 100 arrives at an “abstraction summary” that accurately breaks down discrete portions of the code repository.

In other words, the wiki generation system 100 utilizes a reasoning model to break down a meta-task (creating a wiki) into multiple sub-tasks (e.g., intermediate tasks, such as initially abstracting an outline/table of contents), generates intermediate predictions (e.g., which rich representations should be assigned to which sections of the outline/table of contents), and provides explanations for each intermediate step (e.g., fills in the content for each wiki page).

As mentioned above, in some embodiments, the wiki generation system 100 utilizes the previous wikis 206e to generate the wiki 212. In particular, the wiki generation system 100 can use incremental generation to generate the plurality of rich representations 210 and eventually generate a wiki 212 of the code repository. In some embodiments, incremental generation refers to a process of creating the wiki 212 step-by-step or gradually. In particular, incremental generation refers to a process to break down a building/creation process into discrete manageable steps, which allows for feedback, refinement or corrections at each stage (e.g., rather than generating everything in a single step).

In one or more embodiments, the wiki generation system 100 uses the previous wikis 206e to generate the plurality of rich representations 210 and eventually the wiki 212 by using incremental generation principles. In particular, the wiki generation system 100 accesses previously generated wikis from the autonomous software agent system 104. For example, the wiki generation system 100 accesses the previous wikis 206e that are generated from public code repositories or other third-party code repositories.

In some embodiments, the wiki generation system 100 generates a version of the wiki from accessing previously generated wikis from the autonomous software agent system 104. In particular, the wiki generation system 100 accesses a version of a previous wiki and uses it as a starting point/reference frame. Further, the wiki generation system 100 utilizes a first machine learning model to process a first section of a code repository and generate a subset of the plurality of rich representations.

Moreover, in parallel, the wiki generation system 100 utilizes a second machine learning model to process a second section of the code repository and generate an additional subset of the plurality of rich representations. Furthermore, the wiki generation system 100 utilizes one or more machine learning models to then generate a refined version of the wiki based on the generation of the plurality of rich representations. In other words, the wiki generation system 100 starts with a previous wiki and iteratively refines the previous wiki based on generating different subsets of rich representations of the plurality of rich representations 210.

As mentioned above FIGS. 2B-2F illustrates examples of parts of the wiki 212 generated by the wiki generation system 100. In particular, FIGS. 2B-2C illustrates example system architecture diagrams, FIG. 2D illustrates relevant source files shown on a wiki page as being used as context for generating the wiki page, and FIGS. 2E-2F illustrate computer code conventions extracted from a code repository to generate computer code convention wiki pages. As shown in FIGS. 2B-2C, the wiki generation system identifies different computer component services interacting with each other (e.g., from a code repository) and generates system architecture diagrams.

In one or more embodiments, the system architecture diagram 210a refers to a visual representation that outlines the structure and components of a software system and how those components interact with each other. In other words, the system architecture diagram 210a outlines how a system is organized and relationships between different components (e.g., modules such as diagrams and flow charts of applications, databases, application programming interfaces, third-party integrations, etc.) in the software system. For example, the system architecture diagrams 210a can include logical architecture (e.g., the flow of data), physical architecture (e.g., hardware devices and servers), and cloud architecture. Accordingly, the wiki generation system 100 processes (e.g., using machine learning models of the autonomous software agent system 104) the code repositories to generate the system architecture diagrams 210a of the code repositories.

In one or more embodiments, the wiki generation system 100 indexes a code repository and as part of the indexing process identifies each of the computer component services from computer code in the code repository. In some embodiments, the wiki generation system 100 generates textual embeddings from the computer code. In particular, the wiki generation system 100 assigns a machine learning model to generate the system architecture diagrams 210a from the embeddings generated from the computer code. In other words, the wiki generation system 100 assigns discrete tasks to each machine learning model to generate specific portions of the wiki 212.

Moreover, FIG. 2D shows the wiki generation system generating a wiki page with relevant source files. In particular, the wiki generation system, as part of the indexing process, identifies patterns in the computer code of the code repository. In doing so, the wiki generation system 100 utilizes a machine learning model assigned to identify source files used as context for generating a wiki page. Accordingly, the wiki generation system 100 can generate a section for each wiki page that indicates the relevant source files.

FIG. 2E shows the wiki generation system generating the computer code conventions 210c from the code repository. In one or more embodiments, the computer code conventions 210c refer to guidelines and practices for software developers to follow when adding/editing computer code in the code repository. In particular, the computer code conventions 210c outline guidelines/principles to keep computer code consistent, readable, and maintainable. For example, the computer code conventions 210c include formatting guidelines, naming, structure, and documentation. Accordingly, the wiki generation system 100 processes the code repository (e.g., using machine learning models of the autonomous software agent system 104) to generate the computer code conventions 210c (e.g., by extracting/inferring the conventions or by compiling documents that expressly discuss the compute code conventions).

FIG. 2F shows the wiki generation system 100 generating the computer code documentation 210b from the code repository. In one or more embodiments, the computer code documentation 210b refers to written and/or visual descriptions of the functionality and structure of the code repository. In particular, the computer code documentation 210b refers to an explanation of how different computer code in the code repository operates, how to use the computer code, and how to maintain and add to the code repository.

For example, the computer code documentation 210b can include short or long comments that are related to specific code snippets and explain specific lines or sections of computer code. In some embodiments, the computer code documentation 210b includes README files (e.g., introduces a project and how to setup the project), change logs, and API documentation. Accordingly, the wiki generation system 100 processes the code repositories (e.g., using machine learning models of the autonomous software agent system 104) to generate the computer code documentation 210b. In particular, the wiki generation system 100 can extract various comments and compile them together to create one or more computer code documents. Moreover, in some embodiments, the wiki generation system 100 also generates/abstracts file format features in the one or more code repositories 204.

In addition to the diagrams and documentation shown in FIGS. 2B-2F, in one or more embodiments, the wiki generation system further generates features of a wiki to make the wiki more accessible to a user of a computing device. In some embodiments, the wiki generation system 100 uses a text decoder of the multi-modal large language model to generate a table of contents for features of the code repository. In particular, the wiki generation system 100 parses the code repository and generates an abstraction of the code repository for each section indicated by the plurality of rich representations. In other words, as discussed above, the wiki generation system generates an outline/plan of the code repository that is used to create a wiki.

Moreover, in some embodiments, the wiki generation system 100 utilizes the multi-modal large language model to construct the wiki that includes at least one of a copy-paste function for sections of the wiki, a download documentation function for the wiki, or an edit function for sections of the wiki. In particular, the wiki generation system 100 generates the aforementioned features and provides for display, the wiki with at least one of the copy-paste function for code snippets in the wiki, the download documentation function for code documentation in the wiki, and the edit function to modify one or more images or text in the wiki.

In some embodiments, the wiki generation system 100 generates the aforementioned features by generating (e.g., using one or more machine learning models) computer code for the copy-paste function, the download documentation function, or the edit function. Moreover, the wiki generation system utilizes an image encoder of the multi-modal large language model to generate user interface elements. Further, the wiki generation system 100 maps the computer code for the copy-paste function, the download documentation function, and/or the edit function to the user interface elements.

Furthermore, in some embodiments, the wiki generation system 100 generates an edit functionality feature for the wiki. In particular, the wiki generation system 100 provides an option for a user of a computing device to edit one or more sections of a wiki. For example, the wiki generation system 100 allows a user of a computing device to modify/add text and/or images in the generated wiki. In some embodiments, the wiki generation system 100 receives edit requests and transmits the edit requests to an administrator device for approval. After approval, the wiki generation system 100 can propagate the submitted edits. Thus, the wiki generation system 100 provides the aforementioned features to a user of a computing device when providing the generated wiki.

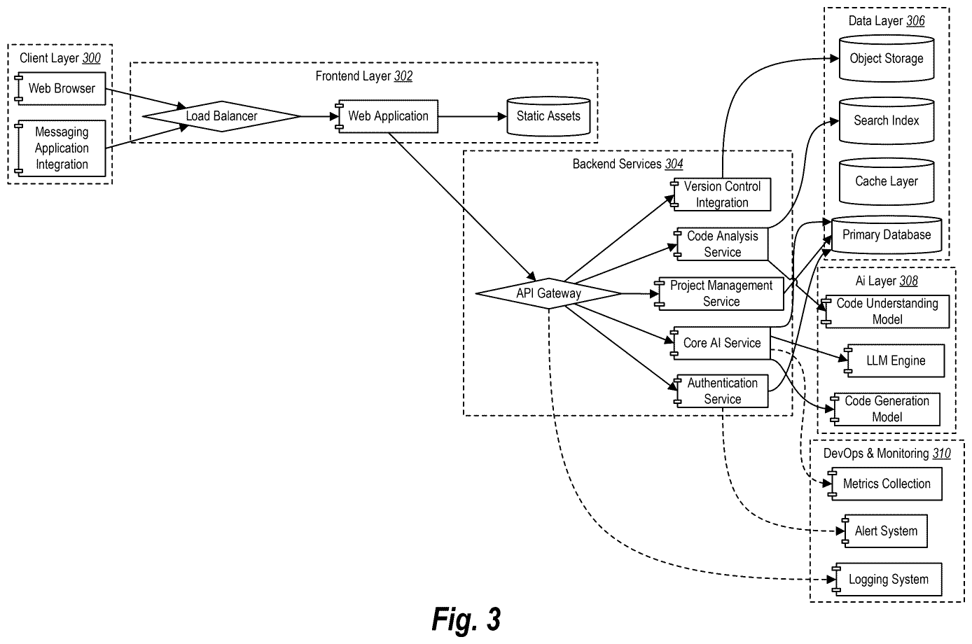

FIG. 3 illustrates architectural details of the wiki generation system 100 using the autonomous software agent system 104 in accordance with one or more embodiments. In particular, the wiki generation system 100 works with the autonomous software agent system 104 to generate rich representations of a code repository (e.g., an index), generate a wiki, provide responses to prompts for questions regarding the wiki, and further deploys an autonomous software agent to perform software coding tasks (e.g., based on context pulled together from a submitted prompt). For the sake of brevity, the below description may describe the autonomous software agent system 104 performing one or more tasks, however it is more accurate to describe the one or more tasks being performed by the wiki generation system 100 using the autonomous software agent system 104.

As shown in FIG. 3, the wiki generation system 100 uses the autonomous software agent system 104 which contains a client layer 300 (e.g., with a web browser, and a messaging application integration), a frontend layer 302 (e.g., with a load balancer (e.g., a system to distribute incoming traffic across multiple servers which optimizes efficiency), a web application (e.g., Devin web application), and static assets (e.g., files that do not dynamically change based on user interactions, such as HTML files, CSS files, JavaScript files, images, etc.)).

Moreover, FIG. 3 shows the wiki generation system 100 uses the autonomous software agent system 104 which also contains backend services 304 (e.g., with an API gateway (e.g., a single entry point for managing and routing API requests from client devices to different microservices/backend systems), a version control integration (e.g., a backend service application to track changes to code such as the connected code repository application like Github), a code analysis service, a project management service (e.g., a software system to track the development of various tasks that a software development team is working on), a core AI service (e.g., artificial intelligence modules or tools to handle the use of machine learning models, natural language processing, and other artificial intelligence tasks), and an authentication service).

In particular, the backend services 304 include applications that all communicate with the backend web-server of the autonomous software agent system, which performs the job of generating an index of a code repository, searching an index of a code repository and orchestrating/managing sessions (Devin sessions), as well as providing the APIs to display data about the autonomous software agent system on computing devices.

Further, FIG. 3 shows a data layer 306 (e.g., with object storage (e.g., storage of unstructured data), search index (e.g., an index of the code repository discussed above), a cache layer (e.g., a layer that temporarily holds frequently accessed or recently computed data), a primary database (e.g., a central data store to hold application data)), an AI layer 308 (e.g., with a code understanding model, an LLM engine, and a code generation model), and a DevOps and Monitoring layer 310 (e.g., with metrics collection, an alert system, and a logging system).

As shown in FIG. 3, the autonomous software agent system 104 utilizes the AI layer 308 to perform a variety of reasoning/generation tasks. In particular, the wiki generation system 100 utilizes the autonomous software agent system 104 to access the AI layer 308 every time a code repository is connected or updated, or a new session is spun up (e.g., each time a new development box is activated). In order to enable the AI layer 308 of the autonomous software agent system 104, the wiki generation system 100 provides various onboarding tools to a user of a computing device. In particular the onboarding tools allows a user to provide access to a Gitprovider, select repositories, assign read access, and assign write access.

In some embodiments, the wiki generation system 100 prompts a user of a computing device for additional access permissions. In particular, the wiki generation system 100 can prompt the user for additional access permissions after generating a response to a prompt or during an autonomous software agent session. For example, the wiki generation system 100 determines during generating a response or executing software coding tasks that additional knowledge/permissions are needed to more thoroughly respond/perform a task.

FIG. 3 illustrates the wiki generation system 100 using the architecture of the autonomous software agent system 104 to generate rich representations of a code repository. In particular, at the client layer 300, the wiki generation system 100 receives a connection between a code repository and the autonomous software agent system 104. In response, to the input via the client layer 300, the wiki generation system 100 further leverages the backend services 304 to analyze the code of the code repository. Moreover, the wiki generation system 100 utilizes the AI layer 308 to generate rich representations of the connected code repository (e.g., and subsequently a wiki of the index).

As further shown in FIG. 3, the AI layer 308 of the autonomous software agent system 104 further includes a code understanding model. In particular, the code understanding model analyzes computer code. In other words, the wiki generation system 100 uses the autonomous software agent system 104 to seek to understand the context and background of a code base/repository to generate the rich representations of the code repository discussed above.

In some embodiments, the wiki generation system 100 uses the autonomous software agent system 104 to extract contextual data from information provided by a user to generate the rich representations using the code understanding model. To illustrate, the wiki generation system 100 uses the autonomous software agent system 104 to parse through a code repository and generate abstraction summaries using the code understanding model and one or more additional artificial intelligence models (e.g., such as the LLM engine).

In some embodiments, the autonomous software agent system 104 uses the AI layer 308 to ingest data from a code base and further utilizes the code understanding model to generate output predictions related to context of the code base. For example, the autonomous software agent system 104 connects to code repositories, and creates knowledge inputs/suggestions based on processing the information in the code repository.

To illustrate, the autonomous software agent system 104 can read through documentation/specifications and then distills that information into data that is relevant for the code understanding model of the autonomous software agent system 104. In addition, after generating the rich representations of the code repository (e.g., and the wiki as discussed above), the wiki generation system 100 further stores the rich representations in the data layer 306 and/or uses the DevOps and Monitoring layer 310 to monitor changes/thresholds related to the connected code repository.

Moreover, after generating the rich representations of the code repository, the wiki generation system 100 further leverages the autonomous software agent system 104 to generate response to prompts regarding the wiki of the code repository. In some embodiments, the wiki generation system 100 receives prompts from the frontend layer 302 submitted via an interface (or where the wiki generation system 100 intakes prompt, whether via the web application, a messaging application, or otherwise) and are sent to the backend services 304 of the autonomous software agent system 104, where the prompt is processed by the one or more artificial intelligence components (e.g., Devin's brain).

As shown in FIG. 3, the wiki generation system 100 utilizes the client layer 300 to receive interactions. In particular, users can submit a prompt of a question regarding a code repository via a Devin Messaging Application Integration, an application programming interface call, or directly through a web browser application of the intelligent search interface. In some embodiments, the messaging application integration lets users prompt the wiki generation system 100 and to further create sessions by tagging a Devin Slackbot in their team's messaging server.

In some embodiments, as shown, the autonomous software agent system 104 utilizes an LLM engine (e.g., a model that selects one or more large language models according to certain parameters/requirements) of an autonomous software agent to generate a response to a prompt. In particular, the autonomous software agent system 104 calls a first large language model for a first task (e.g., generating a first result for a prompt) and a second large language model for a second task (generating a second result for the prompt).

In one or more embodiments, the wiki generation system 100 uses the autonomous software agent system 104 which utilizes the complex architectural design shown in FIG. 3. In particular, the autonomous software agent system 104 includes a natural language processing component (e.g., Devin's Brain) that allows the wiki generation system 100 to understand natural language descriptions (e.g., the functionalities of desired software programs). In some embodiments, the wiki generation system 100 uses the autonomous software agent system 104 to utilize natural language processing to analyze natural language descriptions in a prompt and to extract key functionalities and requirements.

As mentioned above, in some embodiments, the wiki generation system 100 generates a response to the prompt and uses the context from the response to deploy an autonomous software agent. In some embodiments, the wiki generation system 100 uses the autonomous software agent system 104 to spin up a development box, where each spun up development box contains knowledge and the autonomous software agent system from one session to another does not transfer the knowledge over to the next session. In some embodiments, knowledge is a form of “memory” that allows the autonomous software agent system to retrieve information based on specific triggers that might be relevant to the session. As also mentioned, this knowledge (depending on the trigger) is retrievable across all sessions.

As mentioned above, the wiki generation system 100 uses the autonomous software agent system 104 which deploys autonomous software agents that have access to their own machines. In particular, for each new spun up session, the wiki generation system 100 uses the autonomous software agent system 104 to spin up a new development box (e.g., sandbox) which includes a shell, an editor and a bowser. Moreover, the autonomous software agent system 104 allows a development box to be customized in user's workspace (e.g., Devin's Workspace), where the user can save a specific machine snapshot that Devin will use each time it spins up a new development box.

Furthermore, the wiki generation system 100 uses the autonomous software agent system 104 to generate development boxes that are isolated virtual machines, and they can be snapshotted and revived at any time. In particular, the development boxes run on top of a custom hypervisor implemented to support the virtual machine technology. Moreover, the state of a run (e.g., deploying an autonomous software agent) can be rolled-back to an earlier point in time. In running back to an earlier point in time, the wiki generation system 100 uses the autonomous software agent system 104 to roll back both the state of “Devin's brain” (e.g., the knowledge and the progress on a certain task), as well as the state of Devin's machine (e.g., the machine contents).

Moreover, in some embodiments, the wiki generation system 100 uses the autonomous software agent system 104 which offers a virtual private cloud (VPC) deployment solution that allows development boxes to run within a customer's (a set of users) cloud tenant with the “Devin brain” (e.g., a component of the autonomous software agent) interacting with the development boxes over a secure tunnel. All data related to sessions are stored at rest in the customer cloud tenant. Furthermore, each of these development boxes (or sessions) can speak to the customer-hosted services (connected via API integrations).

Further, as already mentioned, the autonomous software agent system 104 includes machine learning models. In particular, the autonomous software agent system 104 utilizes pre-trained machine learning models to translate descriptions (e.g., from a response to a prompt) into computer code. Moreover, the machine learning models utilized by the autonomous software agent system 104 have been trained on vast amounts of computer code data, which allows them to identify patterns and generate functional code. In some embodiments, the autonomous software agent system 104 utilizes the machine learning models to process the extracted information (e.g., key functionalities and requirements). In particular, the autonomous software agent system 104 utilizes the machine learning models to search for patterns and identify similar code structures from their training data.

Additionally, the autonomous software agent system 104 includes a code generation engine. In particular, based on processed information from the natural language processing and the machine learning models, the autonomous software agent system 104 translates the descriptions into actual computer code. In other words, the output of the natural language processing and the machine learning model is pulled into the code generation engine to create viable computer code. In some embodiments, based on identified patterns, the autonomous software agent system 104 utilizes the code generation engine to create functional code responsive to deploying an autonomous software agent after generating a response to a prompt.

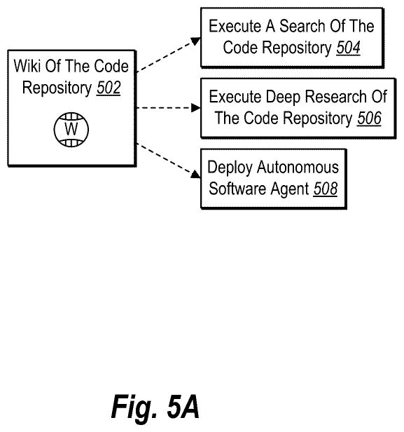

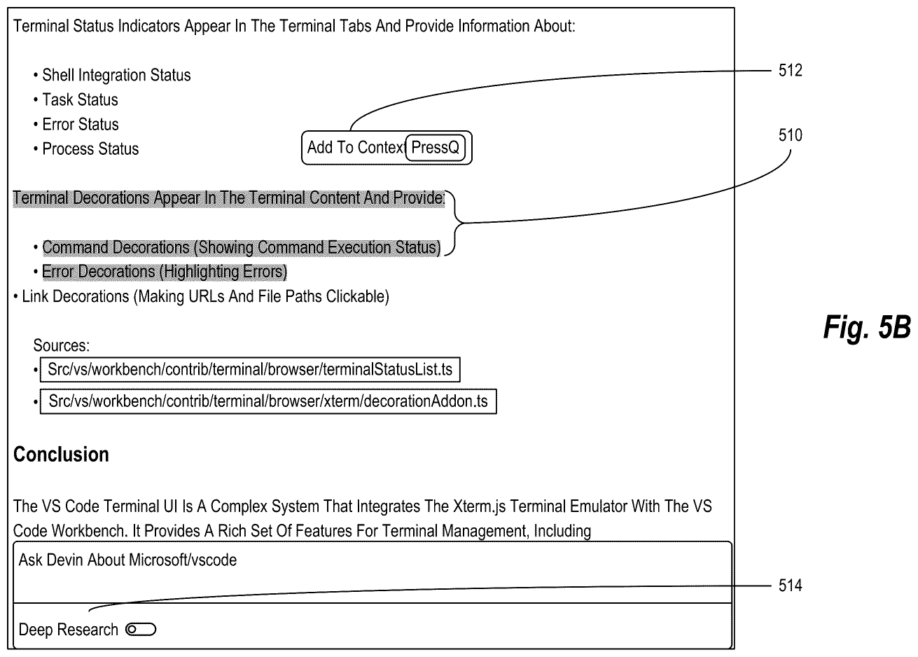

FIG. 3 describes how the wiki generation system 100 uses the autonomous software agent system 104 to perform a variety of tasks such as generating rich representations of a code repository, searching the index of the code repository in response to a prompt, and deploying an autonomous software agent to execute one or more software coding tasks. FIG. 5A shows additional details of the wiki generation system 100 generating a response to a prompt and providing various downstream options in accordance with one or more embodiments.

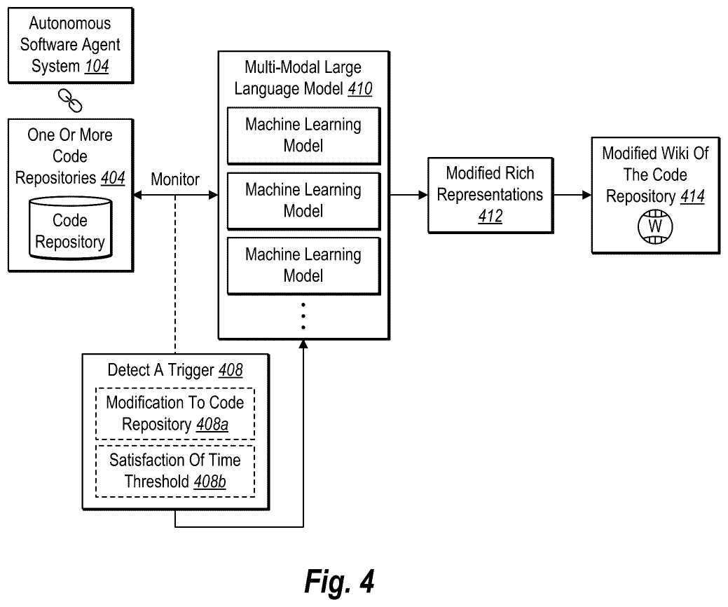

FIG. 4 illustrates the wiki generation system 100 monitoring one or more code repositories to update/modify a generated wiki in accordance with one or more embodiments. For example, FIG. 4 shows the wiki generation system 100 accessing one or more code repositories 404 connected to the autonomous software agent system 104. In particular, FIG. 4 shows the wiki generation system 100 using a multi-modal large language model 410 (e.g., one or more machine learning models) to monitor the one or more code repositories 404.

Furthermore, FIG. 4 shows the wiki generation system 100 performing an act 408 of detecting a trigger. In particular, the wiki generation system 100 detects a trigger based on a modification 408a to a code repository and/or a satisfaction of a time threshold 408b. In some embodiments, the modification 408a refers to alterations to computer code, or files within the one or more code repositories 404.

In particular, in some embodiments, the wiki generation system 100 establishes a modification threshold, which indicates a number of changes that need to be applied to the one or more code repositories 404 before it is considered a trigger. In some embodiments, the wiki generation system 100 can flag certain code snippets as more important than others, and if those “important” code snippets are edited, then the wiki generation system 100 detects the trigger.

In some embodiments, the wiki generation system 100 establishes the time threshold 408b. In particular, the wiki generation system 100 can use a couple of days, a couple of hours, a couple of weeks, etc. as the time threshold 408b. In doing so, the wiki generation system 100 generates the modified rich representations 412 after the satisfaction of the time threshold 408b. In some embodiments, if there were not a significant number of changes (a threshold number of changes) but the time threshold 408b has been satisfied, then the wiki generation system does not generate the modified rich representations 412, as there were not a sufficient number of modifications to the one or more code repositories 404.

As shown, the wiki generation system 100 then utilizes the multi-modal large language model 410 to further generate modified rich representations 412 (e.g., modified relative to initially generated rich representations of the one or more code repositories 404). Additionally, FIG. 4 shows that from the modified rich representations 412, the wiki generation system 100 generates a modified wiki 414 of the code repository. Thus, FIG. 4 illustrates the wiki generation system 100 creating a living and breathing code documentation of the one or more code repositories 404 connected to the autonomous software agent system 104.

FIG. 5A illustrates, a user of a computing device executing a search of a code repository, executing a deep search, and/or deploying an autonomous software agent in accordance with one or more embodiments. For example, FIG. 5A shows the wiki generation system 100 generating a wiki 502 of the code repository and providing the wiki to a user of a computing device. In particular, the wiki generation system 100 can provide one or more functions/features to the user of the computing device accessing the wiki 502.

As shown, in some embodiments, the wiki generation system 100 provides a search functionality of the wiki 502 to perform an act 504 of executing a search of the code repository. For example, the wiki generation system 100 receives a prompt to search the wiki 502 of the code repository and generates a response to the prompt that includes an answer and various supporting sources (e.g., code snippets and file paths) from the code repository. After generating the response, the wiki generation system 100 can then receive a deep research prompt, receive a request to initiate an autonomous software agent 508, and/or receive a follow-up prompt.

In some embodiments, the wiki generation system 100 receives a follow-up prompt. In one or more embodiments, the wiki generation system 100 provides an interface which includes multi-turn functionality. For example, multi-turn functionality refers to the ability for the wiki generation system 100 to engage in multiple exchanges/turns of dialogue with a user of a computing device. For each turn, the wiki generation system 100 “remembers” and responds contextually to prior prompts, creating a more natural and dynamic conversation over multiple steps. Thus, as shown, the wiki generation system 100 receives the follow-up prompt via the interface and generates another response to the follow-up prompt (e.g., by drawing from context of previous prompts/responses).

In one or more embodiments, the deep research prompt refers to a prompt to retrieve knowledge in a comprehensive, nuanced, and in-depth manner. In particular, the deep research prompt is more than a simple question used to elicit a simple response, but rather, the deep research prompt contains clear context, specific and multi-layered parts, and encourages responses that are thorough and scientific/evidence-based.

In one or more embodiments, the wiki generation system 100 receives the deep research prompt which is based on the response, the contents of the response, and contextual data from the user of the computing device that submitted the prompt. In particular, the wiki generation system 100 receives the deep research prompt based on a selection of a deep research element that is provided to the user of the computing device after generating the response. For example, the deep research prompt can include instructions to perform chain-of-thought reasoning and to retrieve knowledge from external sources.

In one or more embodiments, the wiki generation system 100 utilizes advanced reasoning models (e.g., chain-of-thought reasoning models) to break down a deep research prompt/request into intermediate tasks. Due to the advanced reasoning capabilities that break down a task into discrete steps or subtasks, the wiki generation system 100 performs tasks at a higher level of accuracy and efficiency (e.g., relative to existing systems).

As shown in FIG. 5A, the wiki generation system 100 can generate a deep research response by performing an act 506 of executing deep research of the code repository. In particular, the wiki generation system 100 performs the act 506 when it is triggered by the deep research prompt. In particular, the deep research response includes a thorough deep-dive into the index of the code repository (e.g., available to the autonomous software agent system) to generate a response. For example, the deep research response is much more detail-oriented relative to the response and contains extensive code snippets, file paths, and other supporting information responsive to the prompt submitted by the user. In some embodiments, the wiki generation system 100 draws from external systems to generate the deep research response.

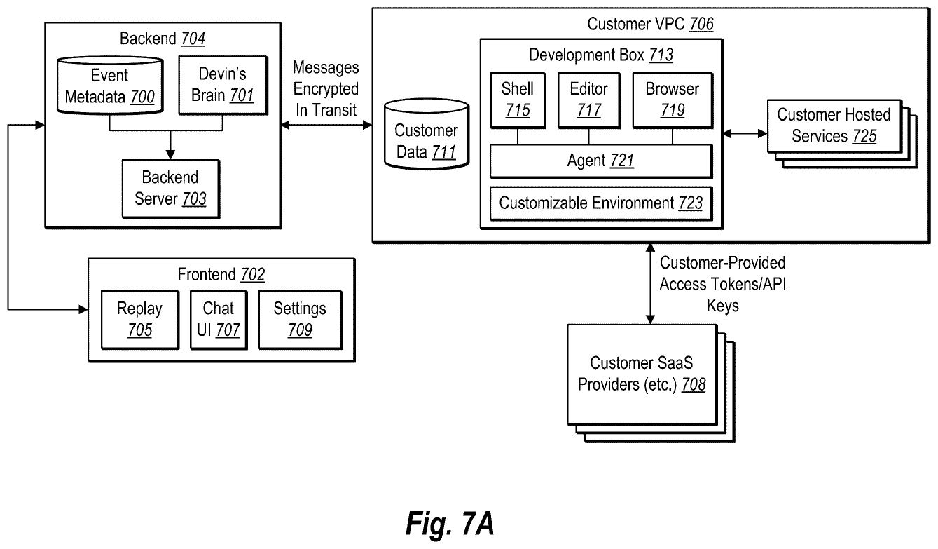

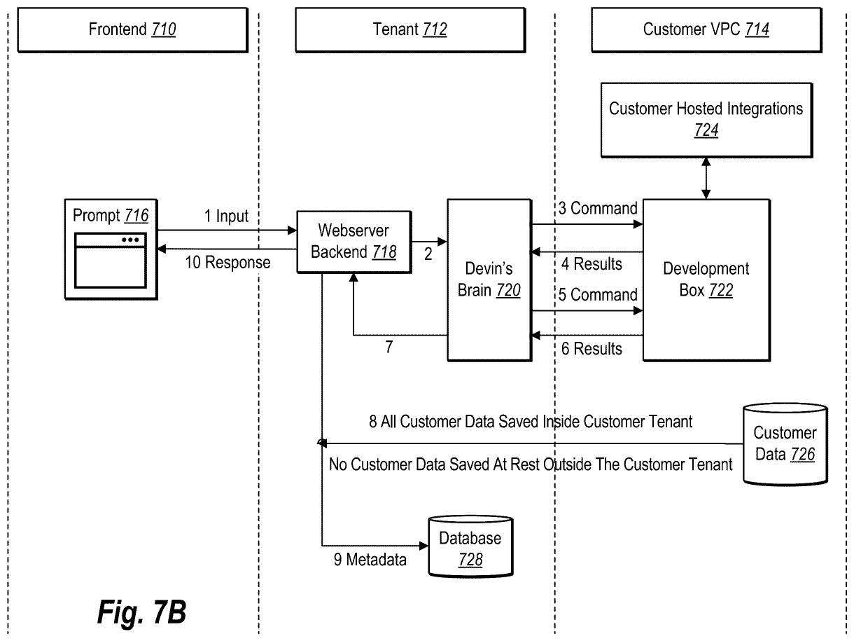

As shown in FIG. 5A, the wiki generation system 100 also receives a request to deploy an autonomous software agent 508. In some embodiments, the wiki generation system 100 receives an indication from a user of the computing device to kick-off an autonomous software agent session. In particular, an autonomous software agent operates as an independent virtual machine computing device and is based on a unique artificial intelligence architecture shown above in FIG. 3 and in FIGS. 7A-7B.

To illustrate, in one or more embodiments, the wiki generation system 100 works with the autonomous software agent system 104 to deploy an autonomous software agent to independently complete software development tasks such as writing computer code tests, adding features to an existing codebase, adding functionality to an existing codebase, developing prototypes, and building integrations between software applications (e.g., based on the context pulled together from the prompt submitted by the user of the computing device).

In particular, the wiki generation system 100 works with the autonomous software agent system 104 to deploy an autonomous software agent that has access to its own virtual machine and the autonomous software agent is enabled to locally write computer code, test computer code, submit requests, and merge code into a codebase. In other words, the wiki generation system 100 works with the autonomous software agent system 104 to deploy one or more software agents to independently perform a variety of non-trivial tasks, which enhances overall efficiency, accuracy, and operational flexibility of code development environments.

FIG. 5B illustrates an example graphical user interface of the wiki generation system 100 providing an option to submit a prompt regarding deep research and/or an option to insert context from a wiki page into a prompt in accordance with one or more embodiments. For example, FIG. 5B shows the wiki generation system 100 receiving user input 510. In particular, FIG. 5B shows the user input 510 as highlighting specific text in the wiki page.

Moreover, FIG. 5B shows that in response to the user input 510 of highlighting text in the wiki page, the wiki generation system 100 can then provide an option 512 to add the highlighted text as context for a prompt (e.g., by user input, such as by “pressing Q”). In particular, as discussed above, the wiki generation system 100 can generate a response to a prompt or deploy an autonomous software agent to perform a task based on a prompt that includes the user input 510. In other words, the user input 510 can be used to generate a prompt to elicit a response regarding a code repository or the user input 510 can be used to generate an autonomous software agent prompt to deploy an autonomous software agent to execute a software coding task.

Furthermore, as shown in FIG. 5B, the wiki generation system 100 provides deep research request 514 as an option for a user of a computing device to select. In particular, in response to a selection of the deep research request 514, the wiki generation system 100 can perform a task of generating a response to a prompt using the deep research principles discussed above. In some embodiments, the wiki generation system 100 pulls together information from the wiki and external sources in response to the deep research request 514. Moreover, in some embodiments, the wiki generation system 100 can further deploy an autonomous software agent based on the information pulled together by the deep research request 514 (e.g., uses the deep research response as an autonomous software agent prompt).

Accordingly, the wiki generation system 100 provides a detailed and thorough wiki generated in a manner that is easy to navigate and efficient for software developers to get up to speed on various complexities of a code repository. Moreover, as a software developer is perusing a generated wiki, the wiki generation system 100 can receive various user inputs (e.g., user input 510). In particular, the wiki generation system 100 can receive user input, generate responses to the user input, and perform software coding tasks. Thus, the wiki generation system 100 streamlines the ability of software development teams to collaborate with creating computer code in an accurate and efficient manner.

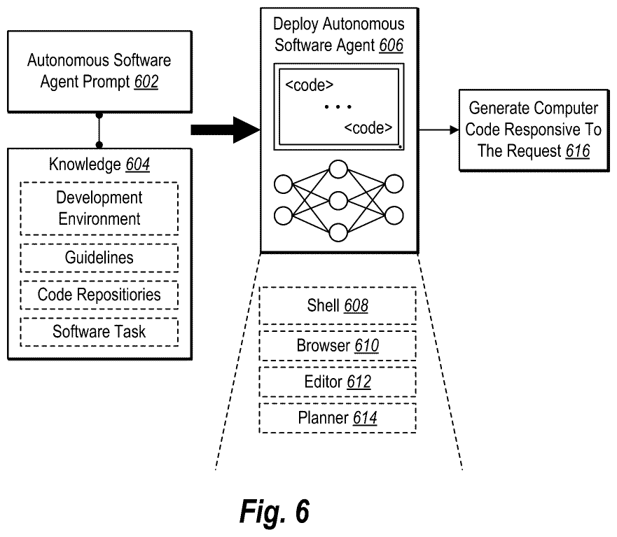

As discussed above, the wiki generation system 100 provides an option for a user of a computing device to kick-off a Devin session (e.g., deploy an autonomous software agent) after submitting a prompt and receiving a response to the prompt. FIG. 6 shows the wiki generation system 100 deploying an autonomous software agent after generating a response to a prompt with a question regarding a wiki of a code repository in accordance with one or more embodiments.

FIG. 6 illustrates an overview of the wiki generation system 100 using the autonomous software agent system 104 to generate computer code by deploying an autonomous software agent that is guided by the context of a response to a prompt submitted via an interface of a generated wiki. For example, FIG. 6 shows the autonomous software agent system 104 accessing/receiving an autonomous software agent prompt 602. In particular, the autonomous software agent prompt 602 refers to a natural language prompt (from a user of a computing device), an application programming interface call, and/or a tag/mention in a messaging application.

In some embodiments, via an API, a user of a computing device can build custom workflows using an API of the autonomous software agent system 104 and programmatically assign tasks for the autonomous software agent system 104 to perform (e.g., after submitting one or more prompts via the intelligent search interface). Further, with the API, users of computing devices can essentially plug in the autonomous software agent system 104 to any of their software development and internal tools.

In some embodiments, the wiki generation system 100 receives an indication (e.g., command+enter) to initiate an autonomous software agent. In particular, the wiki generation system 100 generates the autonomous software agent prompt 602 that includes a generated response to a prompt (e.g., a prompt to search the wiki of the code repository). In some embodiments, the autonomous software agent prompt 602 further includes source information from the generated response and additional contextual data.

In some embodiments, the autonomous software agent system 104 can deploy an autonomous software agent in response to being tagged/mentioned in a messaging application. In particular, users of computing devices can tag the autonomous software agent system 104 directly from conversations they're having with colleagues in the messaging application. Furthermore, the autonomous software agent system 104 will reply directly in the messaging thread and anyone can jump into the thread and provide further instructions (e.g., in addition the autonomous software agent prompt 602) to the autonomous software agent system.

As further shown in FIG. 6, the autonomous software agent system 104 further accesses/receives knowledge 604. In particular, the knowledge 604 can include a development environment, guidelines, code repositories, and/or one or more software tasks. In particular, knowledge refers to a form of “memory” that allows the wiki generation system 100 to utilize the autonomous software agent system 104 to retrieve information based on specific triggers that might be relevant to a session of the autonomous software agent. Further, the knowledge (depending on the trigger) is retrievable across all sessions. In some embodiments, users can specify conditions/triggers for when certain types of knowledge are available to an autonomous software agent.

To illustrate, the wiki generation system 100 uses the autonomous software agent system 104 which utilizes a retrieval-augmented generation (RAG), which refers to retrieving relevant information from an external database or knowledge source. Further, RAG includes using a large language model to generate a response leveraging both the retrieved information and its own internal knowledge base. In particular, RAG includes an input query, information retrieval, and response generation.

As further shown in FIG. 6, the wiki generation system 100 uses the autonomous software agent system 104 which further performs an act 606 of deploying an autonomous software agent (e.g., a cloned virtual machine that is isolated and can perform tasks siloed from other devices). In some embodiments, an autonomous software agent refers to an independent virtual machine computing device that generates and runs code in its own isolated environment. In other words, the autonomous software agent exists independently of a computing device of a user who submitted a prompt to deploy the autonomous software agent and performs tasks based on knowledge that is provided to it. Moreover, as shown in FIG. 6, the wiki generation system 100 uses the autonomous software agent system 104 to further provide to the autonomous software agent a shell 608, a browser 610, an editor 612, and a planner 614.

In other words, the wiki generation system 100 uses the autonomous software agent system 104 to provide the autonomous software agent with its own software development environment to perform individualized tasks and not merely supplementary tasks (e.g., the autonomous software agent can deploy its own codebase by replicating an existing codebase, make changes, implement changes, run tests, etc.). In some embodiments, the autonomous software agent asks permission from a user prior to implementing and computer code changes.

Moreover, because the wiki generation system 100 typically has a thorough and nuanced understanding of a code repository and deploys the autonomous software agent after receiving a prompt about the wiki of the code repository, the wiki generation system 100 generates more accurate and efficient computer code. As mentioned above, the wiki generation system 100 uses the autonomous software agent system 104 to provide the combination of development tools to an autonomous software agent and outperforms existing methods due to its advanced reasoning capabilities. In particular, the autonomous software agent system 104 utilizes an autonomous software agent with a chain-of-though reasoning model to break down meta-tasks into multiple intermediate tasks.

Furthermore, the autonomous software agent system 104 uses the browser to obtain needed information (e.g., to browse blogs, documentation, etc.) responsive to intermediate tasks, uses the shell to make terminal calls (e.g., responsive to intermediate tasks), and further uses the editor to draft computer code (e.g., in an isolated environment) to accomplish each portion of a meta-task. Thus, the combination of software development tools enables the advanced capabilities of an autonomous software agent. Accordingly, the wiki generation system 100 uses the autonomous software agent system 104 which allows a user to perform non-trivial programming tasks using an autonomous software agent that can write, run, test, and deploy computer code (e.g., by initially pulling together relevant context for a software coding task via a prompt submitted to the search interface of the wiki).

In some embodiments, the autonomous software agent includes one or more machine learning models, neural networks, and/or large language models. Thus, the wiki generation system 100 uses the autonomous software agent system 104 to deploy an autonomous software agent that acts as an independent virtual machine computing device with various machine learning components used to analyze, process, and generate information.

In some embodiments, the shell 608 refers to a text-based interface where the wiki generation system 100 uses the autonomous software agent system 104 to input commands that interact directly with a computer's operating system. In some embodiments, the browser 610 refers to an interface to that an autonomous software agent utilizes to browse documentation on the World Wide Web, tests web applications it builds, download/upload information, etc. Moreover, a user of a computing device can jump in to help the autonomous software agent navigate through browsing tasks via an interactive browser.

In some embodiments, the editor 612 refers to where the autonomous software agent writes computer code. In particular, the wiki generation system 100 uses the autonomous software agent system 104 to allow a user to supervise, review and edit the computer code written by the autonomous software agent system. Further, in some embodiments, the planner 614 refers to a running “to do” list that is broken down and laid out by the autonomous software agent system 104 in order to complete a task. In particular, the planner 614 allows a user to visualize how the autonomous software agent deployed by the autonomous software agent system 104 plans and thinks through solving a problem (e.g., in light of the context from the prompt and the response to the prompt). Furthermore, as shown in FIG. 6, the wiki generation system 100 uses the autonomous software agent system 104 to further preform an act 616 of generating computer code responsive to the autonomous software agent prompt 602.

In some embodiments, when a user starts a session, the wiki generation system 100 uses an autonomous software agent to make a plan for the session. In particular, the purpose of the plan is to make sure that the autonomous software agent stays on track. In some embodiments, the wiki generation system 100 causes the autonomous software agent to perform replanning. In particular, either when the autonomous software agent realizes that the regular is infeasible or if the user gives additional feedback when the autonomous software agent is working then the autonomous software agent system 104 causes the autonomous software agent to replan.

In some embodiments, the wiki generation system 100 leverages an LLM or a combination of LLMs to generate a plan for an autonomous software agent. In some embodiments, the wiki generation system 100 further queries an LLM at various points to determine whether a plan is feasible. In particular, the wiki generation system 100 leverages an LLM to determine when the autonomous software agent is going off track, hits a dead end, a user interjects, etc., and generates a new plan.

To generate the plan, the wiki generation system 100 receives a prompt and uses a reasoning model to decompose the prompt into discrete tasks. In particular, the wiki generation system 100 performs advanced reasoning to analyze the prompt into a step-by-step process. For example, the wiki generation system 100 utilizes a chain of thought reasoning model to mimic human-like reasoning by breaking down the prompt/task into smaller, more manageable portions. In doing so, the wiki generation system 100 arrives at more accurate and logical conclusions when attempting to complete a task. In other words, the wiki generation system 100 utilizes a reasoning model to break down a meta-task into multiple sub-tasks (e.g., intermediate tasks), generates intermediate predictions, and provides explanations for each intermediate step.

In some embodiments, computer code includes a set of instructions written in a programming language that a computing device can interpret and execute to perform a specific task. In particular, computer code includes a series of statements and functions that execute specific operations. Further, computer code includes statements written in specific syntax and translatable into machine code to be executed by a computing device.

Further, computer code can include function code and test code. As used herein, the term function code refers to a set of instructions written in a programming language that a computing device can interpret and execute to perform a specific task. Function code can include a series of statements and functions that define specific operations or processes performed by a computer upon execution of the code. In some cases, function code includes statements written in specific syntax and translatable into machine code to be executed by a computing device for performing one or more processes of an overall intent.

As used herein, the term test code refers to computer code that defines a function test for function code. For example, text code can include one or more code segments for determining that the function code satisfies an intent query. In some cases, the autonomous software agent system 104 utilizes test code to test function code. For example, the wiki generation system 100 uses the autonomous software agent system 104 to generate the test code that includes computer code for testing whether the output of function code satisfies an intent query. In some embodiments, test code can also test for different types of errors (e.g., syntax errors and logic errors) and/or for hazardous or harmful function code.

FIGS. 7A-7B illustrates additional details of the architecture of the autonomous software agent system 104 in accordance with one or more embodiments. For example, FIG. 7A shows that for each session of deploying an autonomous software agent (e.g., after pulling together context from a prompt submitted to the search interface of the wiki), the wiki generation system 100 uses the autonomous software agent system 104 to spin up/deploy a Backend 704 that includes a “Devin brain container” paired with “Devin's development box” virtual machine. As mentioned above, Devin's Brain (e.g., the backend components of the autonomous software agent system 104) contains one or more machine learning/artificial intelligence models shown above in FIG. 4 used to process, analyze, and generate data.

As shown in FIG. 7A, the backend 704 includes event metadata 700 (e.g., context surrounding a prompt submitted to the intelligent search interface, a response to the prompt, or other external sources that contain contextual data), Devin's Brain 701 (e.g., one or more machine learning models shown and discussed in FIG. 4), and a backend server 703 (e.g., a server that handles logic, database interactions, authentication, and other services for deploying an autonomous software agent).

Further, FIG. 7A shows the backend interacting with a frontend 702 which includes replay 705 (e.g., a session replay that is a recording of previous user interactions with the wiki generation system 100), Chat UI 707 (e.g., the graphical user interface provided to a user to submit prompts), and settings 709 (e.g., custom settings established by the wiki generation system 100 or by a user). Moreover, the backend 704 communicates with a Customer VPC 706 (e.g., a customer virtual private cloud, which is a dedicated and isolated virtual network within a public cloud service) via encrypted messages. In particular, FIG. 7A shows a development box 713 hosted on the Customer VPC 706 and the Customer VPC 706 further includes customer data 711.

Moreover, the development box 713 further includes a shell 715, an editor 717, a browser 719, an agent 721 (e.g., autonomous software agent), a customizable environment 723 (e.g., playbooks, knowledge, etc.) and customer hosted services 725 (e.g., services or applications hosted and managed by a tenant organization). Additionally, FIG. 7A shows that the Customer VPC 706 can integrate various applications via access tokens/API keys. In particular, the autonomous software agent system can use the development box 713 (e.g., the autonomous software agent) to write various code and make integrations with applications integrated with the Customer VPC 706 (e.g., customer SaaS providers 708).

Additionally, FIG. 7B shows that the autonomous software agent system 104 receives a prompt 716 via a frontend 710. In response to the prompt 716, the wiki generation system 100 utilizes the autonomous software agent system 104 to respond to the prompt 716 with a webserver backend 718 and further pass the information to Devin's Brain 720 (e.g., one or more artificial intelligence models shown above in FIG. 4).

As further shown in FIG. 7B, the autonomous software agent system 104 passes commands/results back and forth between a Customer VPC 714 (e.g., a development box 722) and Devin's Brain 720. In other words, FIG. 7B illustrates the interaction between the frontend 710 of the autonomous software agent system 104, the backend 704 of the autonomous software agent system 104, and an autonomous software agent deployed for performing task at the Customer VPC 714. Furthermore, the development box 722 also accesses customer hosted integrations 724 at the Customer VPC 714.

Additionally, FIG. 7B shows customer data 726 at the Customer VPC 714 which the wiki generation system 100 passes all customer data saved inside customer tenant to the tenant 712 (e.g., and no customer data is saved at rest outside the customer tenant). Moreover, FIG. 7B shows the wiki generation system 100 using the webserver backend 718 to pass metadata to a database 728.

In one or more embodiments, the wiki generation system 100 receives an autonomous software agent prompt and deploys an autonomous software agent, which includes one or more machine learning components (e.g., large language models). In one or more embodiments, the autonomous software agent system 104 utilizes a text encoder to generate a set of text tokens for the autonomous software agent prompt. Moreover, based on the text tokens, the wiki generation system 100 uses the autonomous software agent system 104 to generate a plan (e.g., breaks down the software task), and further reasons how to complete one or more tasks. In particular, the autonomous software agent system 104 uses a development box 722 to communicate with Devin's Brain 720 (e.g., the artificial intelligence components shown in FIG. 3) to determine which shell commands to make, computer code to write (e.g., in the editor), and webpages to browse.

In one or more embodiments, the wiki generation system 100 uses the autonomous software agent system 104 which further utilizes a text encoder to process the autonomous software agent prompt. In particular, the text encoder includes a component of a neural network to transform textual data (e.g., the text prompt) into a numerical representation. For instance, the autonomous software agent system 104 utilizes the text encoder to transform the autonomous software agent prompt into a text encoding (e.g., text tokens). Further, the autonomous software agent system 104 utilizes the text encoder in a variety of ways.

For instance, the wiki generation system 100 utilizes the autonomous software agent system 104 which further utilizes the text encoder to i) determine the frequency of individual words in the text prompt (e.g., each word becomes a feature vector), ii) determines a weight for each word within the text prompt to generate a text vector that captures the importance of words within a text prompt, iii) generates low-dimensional text vectors in a continuous vector space that represents words within the text prompt, and/or iv) generates contextualized text vectors by determining semantic relationships between words within the text prompt.

Furthermore, although not shown in FIGS. 3 and 7A-7B, in one or more embodiments, the wiki generation system 100 utilizes the autonomous software agent system 104 to train Devin's Brain 720 (e.g., artificial intelligence components such as the code generation engine, the natural language processing, and the machine learning models). For example, the autonomous software agent system 104 leverages a set of large language models and fine-tunes each large language model for different tasks. In particular, the autonomous software agent system 104 has a large language model for terminal requests, a large language model for generating computer code, a large language model for generating a plan, and a large language model for determining which webpages to browse.

Moreover, the autonomous software agent system 104 trains Devin's Brain by sending an input task to one or more of the large language models, generates a prediction for the input task, and compares the prediction with a ground truth reference. Based on the comparison, the autonomous software agent system 104 fine-tunes or modifies parameters of one or more large language models (e.g., that are part of Devin's Brain). Thus, at inference time, the wiki generation system 100 utilizes the autonomous software agent system 104 to perform advanced reasoning tasks fine-tuned for specific use cases.

In addition, as alluded to above, the autonomous software agent system 104 trains machine learning models to translate descriptions into code. In some embodiments, the autonomous software agent system 104 trains multiple machine learning models for discrete tasks. In particular, the autonomous software agent system 104 trains a machine learning model to generate specific types of functional code. For example, the autonomous software agent system 104 utilizes a machine learning model to generate computer code from a description and compares the description to a ground truth reference and fine-tunes/modifies parameters of the machine learning model.

Moreover, the autonomous software agent system 104 further continuously learns from feedback and developer interactions. In particular, the autonomous software agent system 104 deploys autonomous software agents that perform a variety of tasks, and in response to prompts and/or feedback, the autonomous software agent system 104 learns from the interactions to improve its capabilities. In other words, the autonomous software agent system 104 fine-tunes the artificial intelligence components in response to updates/feedback received from users.

FIGS. 7A-7B describe various architectural details of the autonomous software agent system 104. In particular, the architectural components of the autonomous software agent system 104 allow the wiki generation system 100 to perform a variety of tasks. To illustrate, the autonomous software agent system 104 performs repetitive coding tasks such as generating boilerplate code, data validation routines, and unit tests. Moreover, the wiki generation system 100 uses the autonomous software agent system 104 to perform code revies and debugging such as analyzing code to identify potential bugs and suggesting fixes/improvements. Furthermore, the wiki generation system 100 uses the autonomous software agent system 104 to perform deployment automation to automate a deployment process of software (e.g., streamlining the transition from development to production).

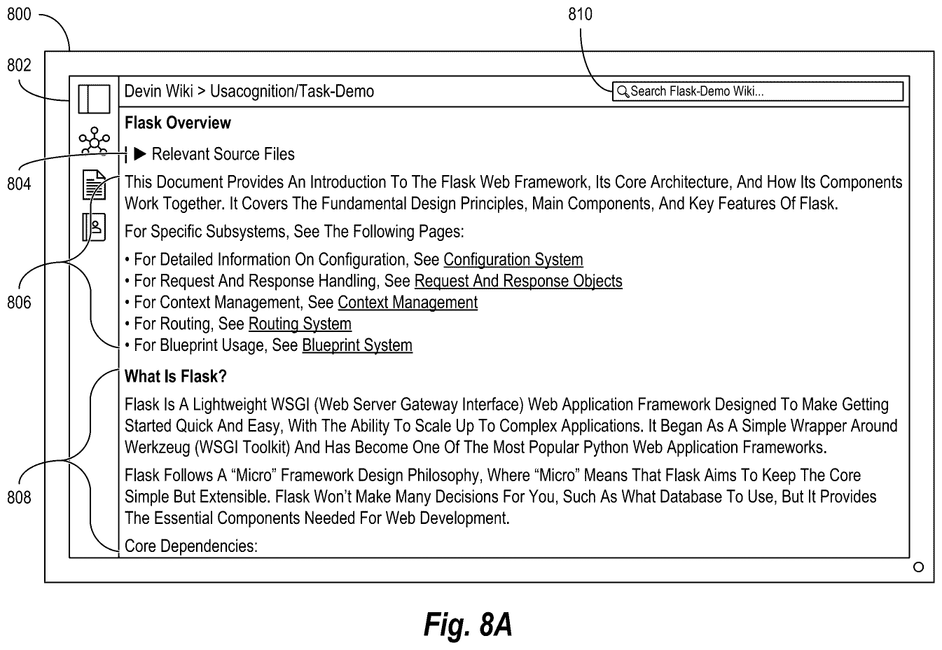

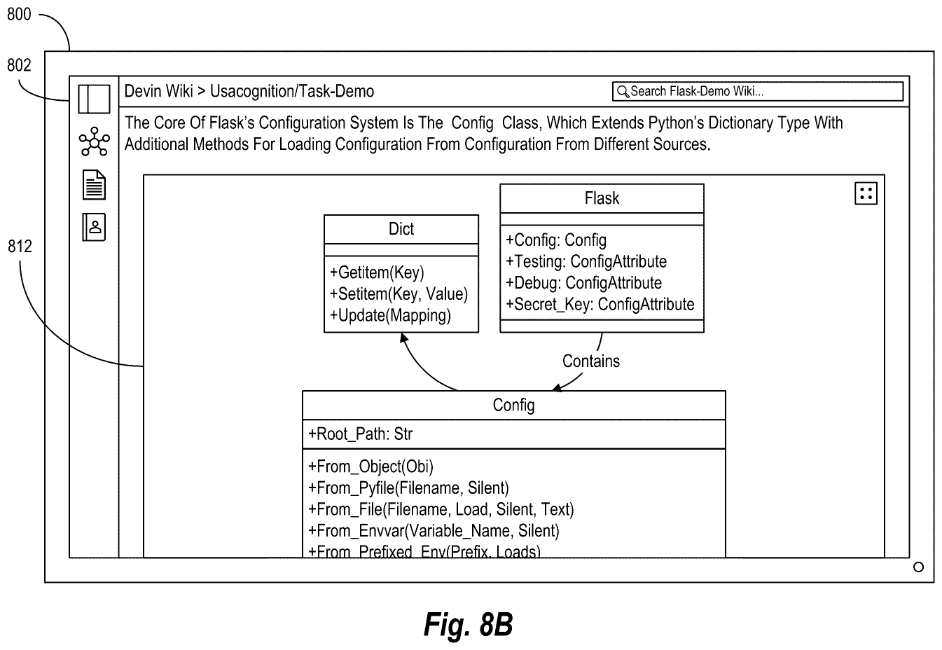

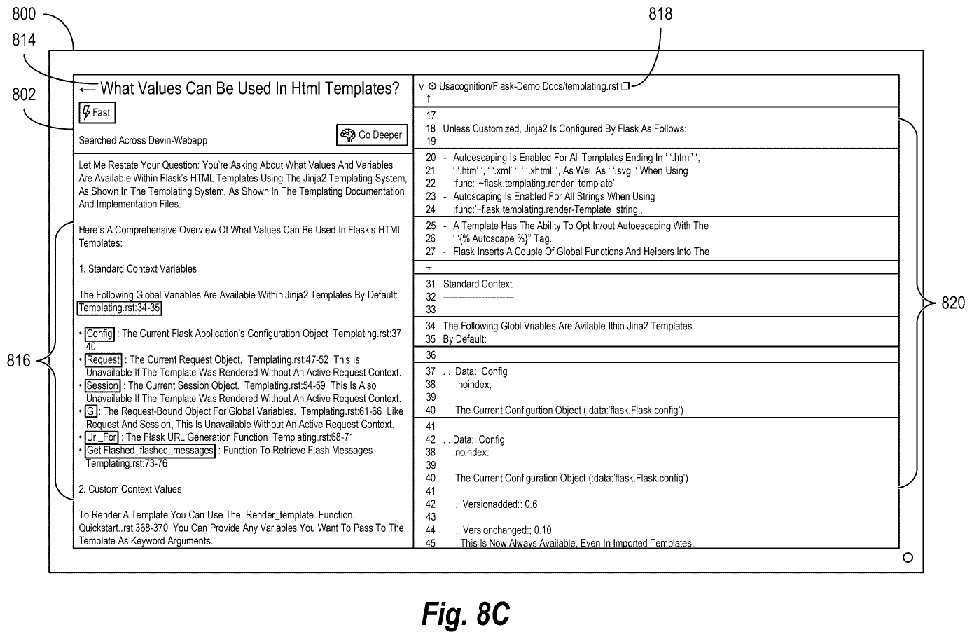

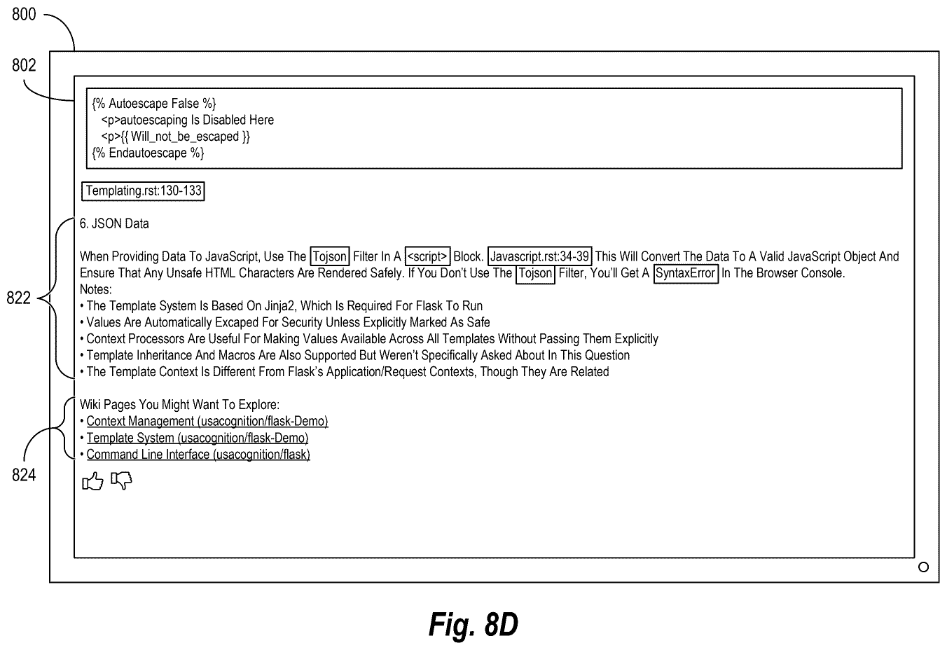

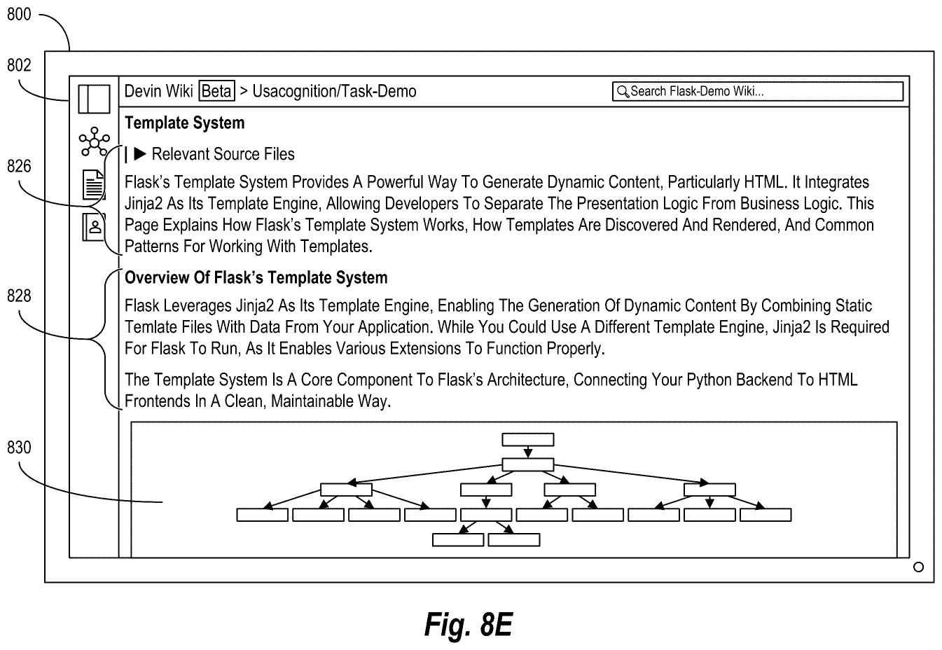

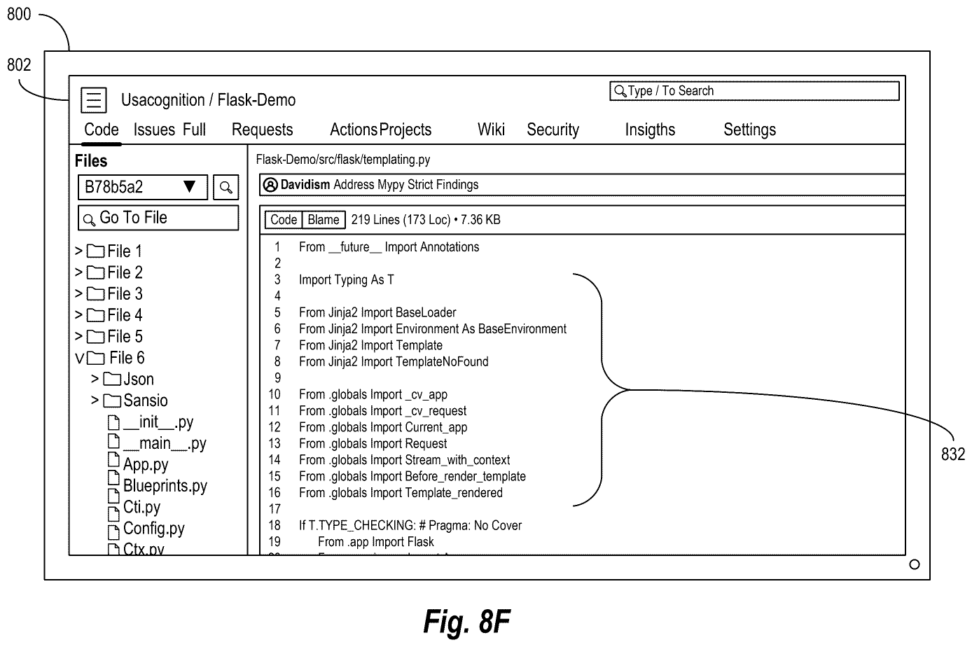

FIGS. 8A-8F illustrate a concrete example of the wiki generation system 100 automatically generating explanations for core features of a code repository. For example, FIG. 8A shows an example wiki generated by the wiki generation system 100. In particular, FIG. 8A shows a graphical user interface 802 of a computing device 800 and an explanation for a “Flask” repository. As shown, FIG. 8A shows an overview of “Flask” with relevant source files 804, links 806 to other pages in the wiki for specific subsystems of “Flask” and explanation 808 of what “Flask” is. Furthermore, FIG. 8A shows a search function 810 to search the “Flask” wiki. In other words, FIG. 8A illustrates that the wiki generation system 100 can generate a wiki that explains the important features for understanding how the “Flask” repository operates.

As shown in FIG. 8B, the wiki generation system 100 is useful for assisting software developers in understanding unfamiliar code repositories and for onboarding new software developers. FIG. 8B shows the wiki generation system 100 providing system architecture diagrams 812 of “Flask” in the generated wiki. In particular, FIG. 8B shows the system architecture diagrams 812 related to “Flask's” configuration system “which extends python's dictionary type with additional methods for loading configuration from configuration from different sources.”

FIG. 8C shows that in addition to a software developer browsing the wiki manually, the wiki can be used by a user of a computing device in “Devin Search” (e.g., an intelligent search interface to search the generated wiki of a code repository). In particular, FIG. 8C shows a prompt 814 of “what values can be used in [Flask] HTML templates?” For example, FIG. 8C shows the wiki generation system 100 (e.g., using the autonomous software agent system 104) to generate a response 816 of “let me restate your question: you're asking about what values and variable are available within Flask's HTML templates using the Jinja2 templating system as shown in the templating system, as shown in the templating documentation, and implementation files.”

FIG. 8C further shows the wiki generation system 100 providing a “comprehensive overview” of what values can be used (e.g., standard context variables and custom context values). Moreover, the right side of FIG. 8C shows relevant code snippets 820 for the generated response that can aid the user of the computing device to view supporting sources for the answer. Additionally, FIG. 8C shows a copy-paste option 818 that allows a user of a computing device to copy one or more code snippets that are provided as part of the response 816.

Moreover, FIG. 8D shows a portion 822 of the response 816 that relates to values that can be used in HTML templates (e.g., JSON data). Furthermore, FIG. 8D shows the wiki generation system 100 further providing (e.g., as part of the generated answer) related pages 824 (e.g., “wiki pages”) that are relevant to the prompt used to elicit the response shown in FIGS. 8C-8D. In particular, FIG. 8D shows wiki pages such as “context management,” “template system,” and “command line interface.”

Moreover, FIG. 8E shows that in response to a selection of the “template system” wiki page shown in the related pages 824 of FIG. 8D, the wiki generation system 100 causes the graphical user interface 802 to transition to the selected wiki page. In particular, FIG. 8E shows relevant source files 826 for the “template system” an overview 828 of “Flask's template system” and a system architecture diagram 830 also related to the template system. Moreover, FIG. 8F shows that the wiki generation system 100 can further provide relevant code 832 for a wiki topic. In particular, FIG. 8F shows the relevant code 832 for the “template system” of “Flask” that is easily accessible from the wiki page of “template system.”

Accordingly, FIGS. 8A-8F illustrates the wiki generation system 100 providing a generated wiki to a user of a computing device (e.g., in response to connecting a code repository to the autonomous software agent system 104). In particular, in some embodiments, FIGS. 8A-8F illustrates an effective method for onboarding a new/less experienced software developer. For example, the generated wiki allows a new software developers to determine where to find specific computer code, where certain computer code changes should be applied, etc.

Although FIGS. 8A-8F illustrate a generated wiki for the “Flask” repository, in one or more embodiments, the wiki generation system 100 provides wikis for a plurality of code repositories to the user of the computing device 800. In particular, wiki generation system 100 provides all wikis for code repositories that are connected to the autonomous software agent system 104. Moreover, in some embodiments, the user of the computing device 800 can navigate between different wikis for different code repositories (e.g., selecting a wiki for a code repository can cause the graphical user interface 802 to display an overview and/or table of contents for that code repository).

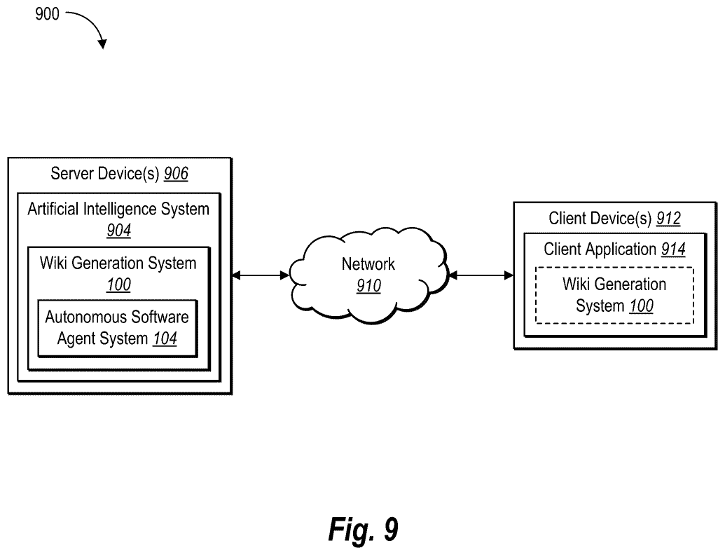

Additional details regarding the wiki generation system 100 will now be provided with reference to the figures. For example, FIG. 9 illustrates a schematic diagram of an exemplary system environment 900 in which the wiki generation system 100 operates. As illustrated in FIG. 9, the system environment 900 includes server device(s) 906, an artificial intelligence system 904, a network 910, and client device(s) 912. Additionally, FIG. 9 illustrates that the artificial intelligence system 904 includes the wiki generation system 100 and the wiki generation system 100 further includes the autonomous software agent system 104.

Although the system environment 900 of FIG. 9 is depicted as having a particular number of components, the system environment 900 is capable of having a different number of additional or alternative components (e.g., a different number of servers, client devices, or other components in communication with the wiki generation system 100 via the network 910). Similarly, although FIG. 9 illustrates a particular arrangement of the server device(s) 906, the network 910, and the client device(s) 912, various additional arrangements are possible.

The server device(s) 906, the network 910, and the client device(s) 912 are communicatively coupled with each other either directly or indirectly (e.g., through the network 910 discussed in greater detail below). Moreover, the server device(s) 906 and the client device(s) 912 include one or more of a variety of computing devices (including one or more computing devices as discussed in greater detail below).

As mentioned above, the system environment 900 includes the server device(s) 906. In one or more embodiments, the server device(s) 906 process input for a request (e.g., to generate rich representations and a wiki in response to connecting a code repository, to generate a response to a prompt to search a code repository, a deep research prompt, a request to configure an autonomous software agent, and/or a request to deploy an autonomous software agent). In one or more embodiments, the server device(s) 906 comprise a data server. In some implementations, the server device(s) 906 comprise a communication server or a web-hosting server. Furthermore, the server device(s) 906 can be associated with the wiki generation system 100 or with a company that deploys the wiki generation system 100.

In some embodiments, the client device(s) 912 includes computing devices associated with the one or more user accounts that submit requests for the wiki generation system 100. In some embodiments, the wiki generation system 100 trains one or more artificial intelligence models such as a code understanding model, one or more large language models, and a code generation model.

In one or more embodiments, the client device(s) 912 includes smartphones, tablets, desktop computers, laptop computers, head-mounted-display devices, or other electronic devices. The client device(s) 912 includes one or more software applications (e.g., a client application 914) for generating content in accordance with the artificial intelligence system 904. In one or more embodiments, the client application 914 includes a software application hosted on the server device(s) 906 accessible by the client device(s) 912 through another application, such as a web browser.

To provide an example implementation, in some embodiments, the wiki generation system 100 on the server device(s) 906 supports the wiki generation system 100 on the client device(s) 912. For instance, in some cases, the wiki generation system 100 on the server device(s) 906 gathers data for the wiki generation system 100. In response, the wiki generation system 100, via the server device(s) 906, provides the information to the client device(s) 912. In other words, the client device(s) 912 obtains (e.g., downloads) the wiki generation system 100 (e.g., and the autonomous software agent system 104) from the server device device(s) 906 that is already trained/optimized. Once downloaded, the wiki generation system 100 on the client device(s) 912 is able to perform tasks (e.g., generative software tasks and/or respond to prompts) independent from the server device(s) 906. In one or more alternative implementations, the wiki generation system 100 generates or learns parameters for one or more artificial intelligence models (e.g., used to implement an autonomous software agent) in whole or in part on the client device(s) 912.

In alternative implementations, the wiki generation system 100 includes a web hosting application that allows the client device(s) 912 to interact with content and services hosted on the server device(s) 906. To illustrate, in one or more implementations, the client device(s) 912 accesses a software application supported by the server device(s) 906. In response, the artificial intelligence system 904 on the server device(s) 906 provides tools for monitoring/modifying/generating indexes, wikis, and/or computer code using the wiki generation system 100 via the autonomous software agent. In other words, the client device(s) 912 does not have to download the wiki generation system 100 while still being able to access/utilize the trained/optimized tools provided by the wiki generation system 100 via a web hosting application.

In some embodiments, the wiki generation system 100 is implemented in whole, or in part, by the individual elements of the system environment 900. For instance, although FIG. 9 illustrates the wiki generation system 100 implemented or hosted on the server device(s) 906, different components of the wiki generation system 100 are able to be implemented by a variety of devices within the system environment 900. For example, one or more (or all) components of the wiki generation system 100 are implemented by a different computing device or a separate server from the server device(s) 906. Indeed, as shown in FIG. 9, the client device(s) 912 includes the wiki generation system 100.

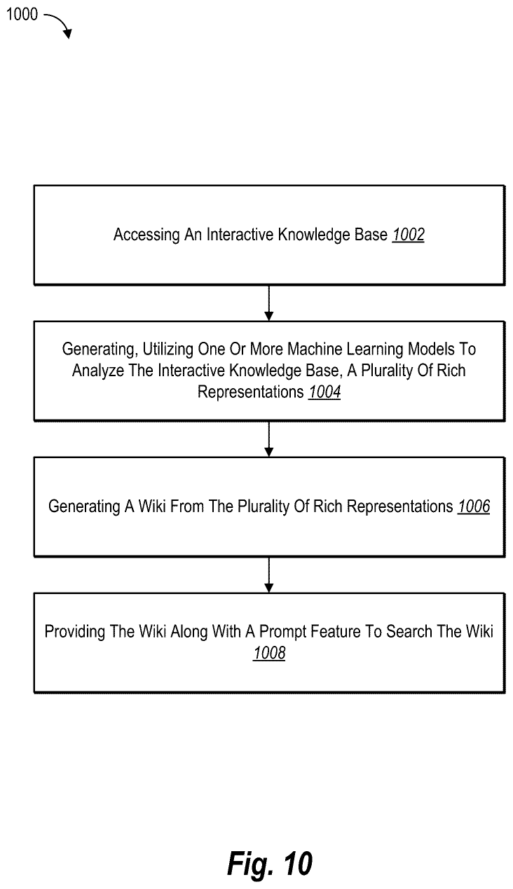

FIG. 10 illustrates a flowchart of a series of acts 1000 for generating a wiki of a code repository in accordance with one or more embodiments. FIG. 10 illustrates acts according to one embodiment, alternative embodiments may omit, add to, reorder, and/or modify any of the acts shown in FIG. 10. In some implementations, the acts of FIG. 10 are performed as part of a method. For example, in some embodiments, the acts of FIG. 10 are performed as part of a computer-implemented method. Alternatively, a non-transitory computer-readable medium stores instructions thereon that, when executed by at least one processor, cause a computing device to perform the acts of FIG. 10. In some embodiments, a system performs the acts of FIG. 10. For example, in one or more embodiments, a system includes at least one memory device. The system further includes at least one server device configured to cause the system to perform the acts of FIG. 10.

The series of acts 1000 includes an act 1002 of accessing an interactive knowledge base. Further, the series of acts 1000 includes an act 1004 of generating, utilizing one or more machine learning models to analyze the interactive knowledge base (e.g., a code repository), a plurality of rich representations. Moreover, the series of acts 1000 includes an act 1006 of generating a wiki from the plurality of rich representations. Further, the series of acts 1000 includes an act 1008 of providing the wiki along with a prompt feature to search the wiki.

In particular, the act 1002 includes accessing, via an autonomous software agent system, a code repository. Further, the act 1004 includes in response to accessing the code repository, generating, utilizing one or more machine learning models to analyze the interactive knowledge base, a plurality of rich representations of the code repository. Moreover, the act 1006 includes generating, utilizing the one or more machine learning models, a wiki from the plurality of rich representations, wherein the wiki comprises a visualization of the plurality of rich representations. Moreover, the act 1008 includes providing, for display in a graphical user interface of a computing device, the wiki along with a prompt feature to search the wiki.

In one or more embodiments, the series of acts 1000 includes generating, utilizing a multi-modal large language model as the one or more machine learning models to process the interactive knowledge base and additional contextual data, the plurality of rich representations, wherein the plurality of rich representations comprises an abstraction summary that indicates system architecture diagrams, the computer code documentation, and computer code conventions of the code repository. In addition, in one or more embodiments, the series of acts 1000 includes generating, utilizing the multi-modal large language model, a plurality of embeddings from the plurality of rich representations. In some embodiments, the series of acts 1000 includes generating, utilizing a decoder of the multi-modal large language model, the wiki by transforming plurality of embeddings into text and images arranged according to the plurality of rich representations.

Further, in one or more embodiments, the series of acts 1000 includes generating, utilizing a text decoder of the multi-modal large language model, a table of contents for features of the code repository. Further, in some embodiments, the series of acts 1000 includes generating, utilizing an image decoder of the multi-modal large language model, diagrams and flow charts of system architecture for the code repository.

Moreover, in one or more embodiments, the series of acts 1000 includes generating, utilizing the multi-modal large language model, at least one of a copy-paste function for sections of the wiki, a download documentation function for the wiki, or an edit function for sections of the wiki. Further, in some embodiments, the series of acts 1000 includes generating, utilizing the one or more machine learning models to analyze the code repository and additional contextual data, the plurality of rich representations of the code repository, wherein the additional contextual data comprises code history, logging system data, ticketing system data, and chat application data.

Further, in one or more embodiments, the series of acts 1000 includes generating, utilizing a first machine learning model of the one or more machine learning models to process a first section of the code repository, a subset of the plurality of rich representations. Moreover, in one or more embodiments, the series of acts 1000 includes in parallel, generating, utilizing a second machine learning model of the one or more machine learning models to process a second section of the code repository, an additional subset of the plurality of rich representations.

Further, in one or more embodiments, the series of acts 1000 includes accessing previously generated wikis from the autonomous software agent system. Further, in one or more embodiments, the series of acts 1000 includes building, utilizing the one or more machine learning models, a version of the wiki from using the previously generated wikis as an outline. Moreover, in one or more embodiments, the series of acts 1000 includes generating, utilizing the one or more machine learning models, a refined version of the wiki based on the generation of the plurality of rich representations.

Additionally, in one or more embodiments, the series of acts 1000 includes monitoring the code repository to detect one or more changes to the code repository. Further, in some embodiments, the series of acts 1000 includes determining a satisfaction of a time threshold corresponding to the code repository. In one or more embodiments, the series of acts 1000 includes generating, utilizing the one or more machine learning models, a modified wiki from a plurality of modified rich representations.

Moreover, in one or more embodiments, series of acts 1000 includes accessing, via an autonomous software agent system, a code repository. In one or more embodiments, the series of acts 1000 includes generating, utilizing one or more machine learning models to analyze the code repository and additional contextual data, a plurality of rich representations of the code repository. In one or more embodiments, the series of acts 1000 includes generating, utilizing the one or more machine learning models, a wiki from the plurality of rich representations, wherein the wiki comprises system architecture diagrams, computer code documentation, and computer code conventions. In some embodiments, the series of acts 1000 includes in response to a trigger corresponding to the code repository, generating, utilizing the one or more machine learning models, a modified wiki from a plurality of modified rich representations.

In some embodiments, the series of acts 1000 includes generating, utilizing a multi-modal large language model as the one or more machine learning models to process the code repository and the additional contextual data comprises code history, logging system data, ticketing system data, and chat application data, the plurality of rich representations, wherein the plurality of rich representations comprises an abstraction summary that indicates system architecture diagrams, computer code documentation, and computer code conventions of the code repository.

In addition, in one or more embodiments, the series of acts 1000 includes generating, utilizing the multi-modal large language model, a plurality of visual embeddings and a plurality of text embeddings from the plurality of rich representations. Further, in one or more embodiments, the series of acts 1000 includes generating, utilizing a plurality of decoders of the multi-modal large language model, the wiki by transforming the plurality of visual embeddings into images and the plurality of text embeddings into text.

Further, in some embodiments, the series of acts 1000 includes generating, utilizing the multi-modal large language model, at least one of a copy-paste function for sections of the wiki, a download documentation function for the wiki, or an edit function for sections of the wiki. In some embodiments, the series of acts 1000 includes providing, for display in a graphical user interface of a computing device, the wiki with at least one of the copy-paste function for code snippets in the wiki, the download documentation function for code documentation in the wiki, and the edit function to modify one or more images or text in the wiki.

Moreover, in some embodiments, the series of acts 1000 includes generating computer code for the copy-paste function, the download documentation function, or the edit function. In one or more embodiments, the series of acts 1000 includes generating, utilizing an image encoder of the multi-modal large language model, user interface elements. Furthermore, in one or more embodiments, the series of acts 1000 includes mapping the computer code for the copy-paste function, the download documentation function, or the edit function to the user interface elements.

Moreover, in one or more embodiments, the series of acts 1000 includes generating a version of the wiki from accessing previously generated wikis from the autonomous software agent system. Moreover, in some embodiments, the series of acts 1000 includes generating, utilizing a first machine learning model of the one or more machine learning models to process a first section of the code repository, a subset of the plurality of rich representations.

In one or more embodiments, the series of acts 1000 includes in parallel, generating, utilizing a second machine learning model of the one or more machine learning models to process a second section of the code repository, an additional subset of the plurality of rich representations. Furthermore, in one or more embodiments, the series of acts 1000 includes generating, utilizing the one or more machine learning models, a refined version of the wiki based on the generation of the plurality of rich representations.

Moreover, in one or more embodiments, the series of acts 1000 includes accessing, via an autonomous software agent system, a code repository. In one or more embodiments, the series of acts 1000 includes in response to accessing the code repository, generating, utilizing one or more machine learning models to analyze the code repository, a plurality of rich representations of the code repository. In one or more embodiments, the series of acts 1000 includes generating, utilizing the one or more machine learning models, a wiki from the plurality of rich representations, wherein the wiki comprises system architecture diagrams, computer code documentation, and computer code conventions. In some embodiments, the series of acts 1000 includes providing, for display in graphical user interface of a computing device, the wiki along with a prompt feature to search the wiki.

In one or more embodiments, the series of acts 1000 includes generating, utilizing a multi-modal large language model as the one or more machine learning models to process the code repository and additional contextual data, the plurality of rich representations, wherein the plurality of rich representations comprises an abstraction summary of the code repository. In one or more embodiments, the series of acts 1000 includes generating, utilizing the multi-modal large language model, a plurality of embeddings from the plurality of rich representations.

Moreover, in some embodiments, the series of acts 1000 includes generating, utilizing a decoder of the multi-modal large language model, the wiki by transforming plurality of embeddings into text and images arranged according to a structure and hierarchy indicated by the plurality of rich representations. Further, in some embodiments, the series of acts 1000 includes generating, utilizing the one or more machine learning models to analyze the code repository and data external to the code repository comprising code history, logging system data, ticketing system data, and chat application data, the plurality of rich representations of the code repository.

Moreover, in some embodiments, the series of acts 1000 includes monitoring the code repository to detect one or more changes to the code repository. Additionally, in some embodiments, the series of acts 1000 includes in response to detecting a change to the code repository, generating, utilizing the one or more machine learning models, a plurality of modified rich representations. Further, in some embodiments, the series of acts 1000 includes generating, utilizing the one or more machine learning models, a modified wiki from the plurality of modified rich representations.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

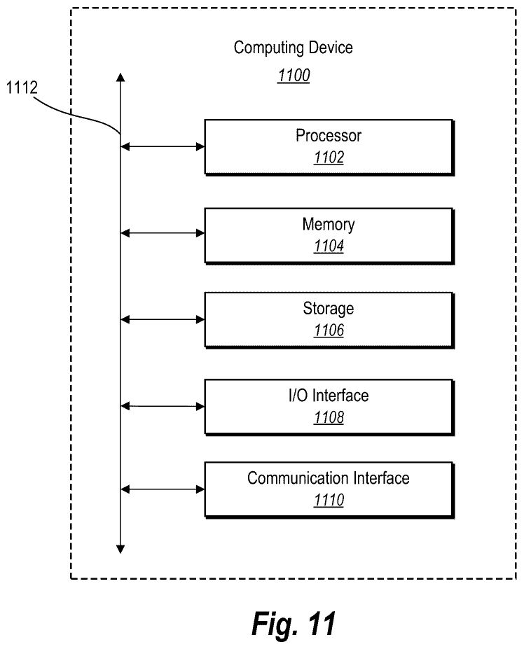

FIG. 11 illustrates a block diagram of an example computing device 1100 that may be configured to perform one or more of the processes described above. One will appreciate that one or more computing devices, such as the computing device 1100 may represent the computing devices described above (e.g., the server device(s) 906 and/or the client device(s) 912). In one or more embodiments, the computing device 1100 may be a mobile device (e.g., a mobile telephone, a smartphone, a PDA, a tablet, a laptop, a camera, a tracker, a watch, a wearable device). In some embodiments, the computing device 1100 may be a non-mobile device (e.g., a desktop computer or another type of client device). Further, the computing device 1100 may be a server device that includes cloud-based processing and storage capabilities.

As shown in FIG. 11, the computing device 1100 can include one or more processor(s) 1102, memory 1104, a storage device 1106, input/output interfaces 1108 (or “I/O interfaces 1108”), and a communication interface 1110, which may be communicatively coupled by way of a communication infrastructure (e.g., bus 1112). While the computing device 1100 is shown in FIG. 11, the components illustrated in FIG. 11 are not intended to be limiting. Additional or alternative components may be used in other embodiments. Furthermore, in certain embodiments, the computing device 1100 includes fewer components than those shown in FIG. 11. Components of the computing device 1100 shown in FIG. 11 will now be described in additional detail.

In particular embodiments, the processor(s) 1102 include hardware for executing instructions, such as those making up a computer program. As an example, and not by way of limitation, to execute instructions, the processor(s) 1102 may retrieve (or fetch) the instructions from an internal register, an internal cache, memory 1104, or a storage device 1106 and decode and execute them.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1104 may be internal or distributed memory.

The computing device 1100 includes a storage device 1106 including storage for storing data or instructions. As an example, and not by way of limitation, the storage device 1106 can include a non-transitory storage medium described above. The storage device 1106 may include a hard disk drive (HDD), flash memory, a Universal Serial Bus (USB) drive or a combination these or other storage devices.

As shown, the computing device 1100 includes one or more I/O interfaces 1108, which are provided to allow a user to provide input to (such as user strokes), receive output from, and otherwise transfer data to and from the computing device 1100. These I/O interfaces 1108 may include a mouse, keypad or a keyboard, a touch screen, camera, optical scanner, network interface, modem, other known I/O devices or a combination of such I/O interfaces 1108. The touch screen may be activated with a stylus or a finger.

The I/O interfaces 1108 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1108 are configured to provide graphical data to a display for presentation to a user. The graphical data may be representative of one or more graphical user interfaces and/or any other graphical content as may serve a particular implementation.

The computing device 1100 can further include a communication interface 1110. The communication interface 1110 can include hardware, software, or both. The communication interface 1110 provides one or more interfaces for communication (such as, for example, packet-based communication) between the computing device and one or more other computing devices or one or more networks. As an example, and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI. The computing device 1100 can further include a bus 1112. The bus 1112 can include hardware, software, or both that connects components of computing device 1100 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed:

1. A computer-implemented method comprising:
accessing, via an autonomous software agent system, an interactive knowledge base;
in response to accessing the interactive knowledge base, generating, utilizing one or more machine learning models to analyze the interactive knowledge base, a plurality of rich representations of the interactive knowledge base;
generating, utilizing the one or more machine learning models, a wiki from the plurality of rich representations, wherein the wiki comprises a visualization of the plurality of rich representations; and
providing, for display in a graphical user interface of a computing device, the wiki along with a prompt feature to search the wiki.

2. The computer-implemented method of claim 1, wherein generating the plurality of rich representations of the interactive knowledge base comprises:
generating, utilizing a multi-modal large language model as the one or more machine learning models to process the interactive knowledge base and additional contextual data, the plurality of rich representations,
wherein the plurality of rich representations comprises an abstraction summary that indicates system architecture diagrams, computer code documentation, and computer code conventions of a code repository.

3. The computer-implemented method of claim 1, wherein generating the wiki from the plurality of rich representations comprises utilizing a multi-modal large language model to construct the wiki by:
generating, utilizing the multi-modal large language model, a plurality of embeddings from the plurality of rich representations; and
generating, utilizing a decoder of the multi-modal large language model, the wiki by transforming plurality of embeddings into text and images arranged according to the plurality of rich representations.

4. The computer-implemented method of claim 3, wherein utilizing the multi-modal large language model to construct the wiki comprises:
generating, utilizing a text decoder of the multi-modal large language model, a table of contents for features of the interactive knowledge base; and
generating, utilizing an image decoder of the multi-modal large language model, diagrams and flow charts of system architecture for the interactive knowledge base.

5. The computer-implemented method of claim 3, wherein utilizing the multi-modal large language model to construct the wiki comprises generating, utilizing the multi-modal large language model, at least one of a copy-paste function for sections of the wiki, a download documentation function for the wiki, or an edit function for sections of the wiki.

6. The computer-implemented method of claim 1, wherein generating the plurality of rich representations comprises:
generating, utilizing the one or more machine learning models to analyze the interactive knowledge base and additional contextual data, the plurality of rich representations of the interactive knowledge base,
wherein the additional contextual data comprises code history, logging system data, ticketing system data, and chat application data.

7. The computer-implemented method of claim 1, wherein generating the plurality of rich representations comprises:
generating, utilizing a first machine learning model of the one or more machine learning models to process a first section of the interactive knowledge base, a subset of the plurality of rich representations; and
in parallel, generating, utilizing a second machine learning model of the one or more machine learning models to process a second section of the interactive knowledge base, an additional subset of the plurality of rich representations.

8. The computer-implemented method of claim 1, wherein generating the wiki comprises:
accessing previously generated wikis from the autonomous software agent system;
building, utilizing the one or more machine learning models, a version of the wiki from using the previously generated wikis as an outline; and
generating, utilizing the one or more machine learning models, a refined version of the wiki based on the generation of the plurality of rich representations.

9. The computer-implemented method of claim 1, further comprising:
monitoring the interactive knowledge base to detect one or more changes to the interactive knowledge base; or
determining a satisfaction of a time threshold corresponding to the interactive knowledge base; and
generating, utilizing the one or more machine learning models, a modified wiki from a plurality of modified rich representations.

10. A system comprising:
one or more memory devices; and
one or more processors coupled to the one or more memory devices, configured to cause the system to:
access, via an autonomous software agent system, a code repository;
generate, utilizing one or more machine learning models to analyze the code repository and additional contextual data, a plurality of rich representations of the code repository;
generate, utilizing the one or more machine learning models, a wiki from the plurality of rich representations, wherein the wiki comprises system architecture diagrams, computer code documentation, and computer code conventions; and
in response to a trigger corresponding to the code repository, generate, utilizing the one or more machine learning models, a modified wiki from a plurality of modified rich representations.

11. The system of claim 10, wherein the one or more processors are configured to cause the system to generate the plurality of rich representations of the code repository by:
generating, utilizing a multi-modal large language model as the one or more machine learning models to process the code repository and the additional contextual data comprises code history, logging system data, ticketing system data, and chat application data, the plurality of rich representations,
wherein the plurality of rich representations comprises an abstraction summary that indicates system architecture diagrams, computer code documentation, and computer code conventions of the code repository.

12. The system of claim 10, wherein the one or more processors are configured to cause the system to generate the wiki from the plurality of rich representations comprises utilizing a multi-modal large language model to construct the wiki by:
generating, utilizing the multi-modal large language model, a plurality of visual embeddings and a plurality of text embeddings from the plurality of rich representations; and
generating, utilizing a plurality of decoders of the multi-modal large language model, the wiki by transforming the plurality of visual embeddings into images and the plurality of text embeddings into text.

13. The system of claim 12, wherein the one or more processors are configured to cause the system to utilize the multi-modal large language model to construct the wiki by:
generating, utilizing the multi-modal large language model, at least one of a copy-paste function for sections of the wiki, a download documentation function for the wiki, or an edit function for sections of the wiki; and
providing, for display in a graphical user interface of a computing device, the wiki with at least one of the copy-paste function for code snippets in the wiki, the download documentation function for code documentation in the wiki, and the edit function to modify one or more images or text in the wiki.

14. The system of claim 13, wherein generating the copy-paste function, the download documentation function, or the edit function comprises:
generating computer code for the copy-paste function, the download documentation function, or the edit function;
generating, utilizing an image encoder of the multi-modal large language model, user interface elements; and
mapping the computer code for the copy-paste function, the download documentation function, or the edit function to the user interface elements.

15. The system of claim 10, wherein the one or more processors are configured to cause the system to generate the wiki utilizing incremental generation by:
generating a version of the wiki from accessing previously generated wikis from the autonomous software agent system;
generating, utilizing a first machine learning model of the one or more machine learning models to process a first section of the code repository, a subset of the plurality of rich representations;
in parallel, generating, utilizing a second machine learning model of the one or more machine learning models to process a second section of the code repository, an additional subset of the plurality of rich representations; and
generating, utilizing the one or more machine learning models, a refined version of the wiki based on the generation of the plurality of rich representations.

16. A non-transitory computer-readable medium storing executable instructions which, when executed by at least one processing device, cause the at least one processing device to perform operations comprising:
accessing, via an autonomous software agent system, a code repository;
in response to accessing the code repository, generating, utilizing one or more machine learning models to analyze the code repository, a plurality of rich representations of the code repository;
generating, utilizing the one or more machine learning models, a wiki from the plurality of rich representations, wherein the wiki comprises system architecture diagrams, computer code documentation, and computer code conventions; and
providing, for display in graphical user interface of a computing device, the wiki along with a prompt feature to search the wiki.

17. The non-transitory computer-readable medium of claim 16, generating the plurality of rich representations of the code repository comprises generating, utilizing a multi-modal large language model as the one or more machine learning models to process the code repository and additional contextual data, the plurality of rich representations, wherein the plurality of rich representations comprises an abstraction summary of the code repository.

18. The non-transitory computer-readable medium of claim 16, wherein generating the wiki from the plurality of rich representations comprises utilizing a multi-modal large language model to construct the wiki by:
generating, utilizing the multi-modal large language model, a plurality of embeddings from the plurality of rich representations; and
generating, utilizing a decoder of the multi-modal large language model, the wiki by transforming plurality of embeddings into text and images arranged according to a structure and hierarchy indicated by the plurality of rich representations.

19. The non-transitory computer-readable medium of claim 18, wherein generating the plurality of rich representations comprises generating, utilizing the one or more machine learning models to analyze the code repository and data external to the code repository comprising code history, logging system data, ticketing system data, and chat application data, the plurality of rich representations of the code repository.

20. The non-transitory computer-readable medium of claim 16, wherein the operations further comprise:
monitoring the code repository to detect one or more changes to the code repository;
in response to detecting a change to the code repository, generating, utilizing the one or more machine learning models, a plurality of modified rich representations; and
generating, utilizing the one or more machine learning models, a modified wiki from the plurality of modified rich representations.
